(19) United States
(12) Patent Application Publication
(10) Pub. No.: US 2022/0335863 A1
(43) Pub. Date: Oct. 20, 2022

(54) DISPLAY ASSEMBLY WITH MODULAR CONNECTORS

(71) Applicant: Atomic Design, Inc., Lititz, PA (US)

(72) Inventors: Nicolas Artale, Lancaster, PA (US); Conway S. Allison, East Petersburg, PA (US)

(73) Assignee: Atomic Design, Inc., Lititz, PA (US)

(21) Appl. No.: 17/855,093

(22) Filed: Jun. 30, 2022

Related U.S. Application Data
(63) Continuation-in-part of application No. 16/582,402, filed on Sep. 25, 2019.

(51) Int. Cl. G09F 7/18

(52) U.S. Cl. CPC G09F 7/18; G09F 2007/1843; G09F 2007/1891

(57) ABSTRACT

A modular display system is provided, and includes a frame having peripheral sidewalls with a plurality of keyhole inserts and mount inserts provided thereabout, each of the plurality of keyhole inserts includes an upper insert section and a lower insert section positioned below and in communication with the upper insert section, each of the plurality of mount inserts includes a fastener receiving passageway and a head accommodation cavity positioned in front and in communication with the fastener receiving passageway. Further including, a panel having a frame with a plurality of raised edging fasteners positioned to correspond with the plurality of keyhole inserts.

### CROSS REFERENCE TO RELATED APPLICATION

This application is a continuation-in-part of the U.S. application Ser. No. 16/582,402, filed on Sep. 25, 2019.

### FIELD OF THE INVENTION

The present disclosure relates to display systems, and more particularly, to a display assembly including a modular framing and connector system.

### BACKGROUND

Visual displays are widely used for many different purposes including marketing, sales and entertainment. Displays or other visual elements may take on many different forms (e.g., shapes and sizes) depending on both artistic and structural specifications of the element. Production and installation of these displays or other design elements, particular in large-scale, are often time consuming, mechanically complex and thus costly. Further, many of these displays may be used only temporarily, leading to unnecessary waste, or may require periodic artistic and/or structural alterations thereto. These updates are likewise time consuming as well as expensive. Accordingly, there is a need for a display system or assembly which is modular in nature, and offers convenient assembly and scalability, as well as a system which is easily modifiable and reusable both structurally as well as artistically. There is also a need for a display and framing system which utilizes as many common or shared parts as possible, further increasing efficiency and usability.

In one embodiment of the present disclosure, a modular display system or assembly is provided. The system includes a plurality of interconnected frames, with each of the frames having a sidewall connected to sidewall of another one of the frames by a frame connector. At least one panel is removably attached to a front face of at least one of the plurality of interconnected frames by a panel connector. The system further includes a border element removably attached to an exterior side of a sidewall of one of the plurality of interconnected frames by a border connector. The system is mountable to an adjacent mounting surface, such as a wall, via a mounting cleat extending from a sidewall of one of the plurality of interconnected frames. Each of the frames includes a plurality of connector receiving sections defined by at least one sidewall of the frame and arranged about a perimeter thereof. The connector receiving sections define a commonly-sized recess formed through the at least one sidewall in a width direction thereof and are configured to accept each of the frame connector, the border connector and the mounting cleat therein.

In another embodiment, a modular display system includes a plurality of frames. Each of the frames include at least one sidewall and a plurality of connector receiving sections defined by the at least one sidewall and arranged about a perimeter of the frame. Each connector receiving section defines a recess formed through the at least one sidewall in a width direction thereof. The system further includes at least one frame connector selectively fixable within connector receiving sections of two frames of the plurality of frames for connecting the two frames sidewalls together. The recess of each connector receiving section includes a profile tapering in the width direction from an interior side of the at least one sidewall to an exterior side of the sidewall.

In another embodiment, a modular display system, includes a frame having peripheral sidewalls with a plurality of keyhole inserts and mount inserts provided thereabout, each of the plurality of keyhole inserts includes an upper insert section and a lower insert section positioned below and in communication with the upper insert section, each of the plurality of mount inserts includes a fastener receiving passageway and a head accommodation cavity positioned in front and in communication with the fastener receiving passageway. Further including, a panel having a frame with a plurality of raised edging fasteners positioned to correspond with the plurality of keyhole inserts, each of the plurality of raised edging fasteners having a spacer with spacer walls and a flanged collar positioned on top of the spacer walls, the spacer wall dimensioned to fit in the lower insert section and the flanged collar spaced to fit in the upper insert section.

Other objects and advantages of the present invention will be apparent by the following description with reference to the accompanying drawings and will be helpful for a comprehensive understanding to the present invention.

### BRIEF DESCRIPTION OF THE DRAWINGS

The above and other features of the disclosure will become more apparent by describing in detail exemplary embodiments thereof with reference to the accompanying drawings, in which:

FIG. 1 is a perspective view of an assembled panel system according to an embodiment of the present disclosure;

FIG. 2 is perspective view of the panel system of FIG. 1, with the exterior panels removed to reveal a modular frame assembly;

FIG. 3 is perspective view of a portion of the frame assembly of FIG. 2;

FIG. 4 is a front view of an exemplary frame according to an embodiment of the present disclosure;

FIG. 5 is a first cross-sectional view of the frame of FIG. 4 taken along line 5-5 of FIG. 4;

FIG. 6 is a second cross-sectional view of the frame of FIG. 4 taken along line 6-6 of FIG. 4;

FIG. 7 is a partial perspective view of a panel connector or connector assembly according to an embodiment of the present disclosure in a detached state;

FIG. 8 is a cross-sectional view of the panel connector of FIG. 7 in an attached state;

FIG. 9 is a partial perspective view of another panel connector to an embodiment of the present disclosure in a detached state;

FIG. 10 is a cross-sectional view of the panel connector of FIG. 9 in an attached state;

FIG. 11 is a perspective view of a cleat or hanger connector according to an embodiment of the present disclosure;

FIG. 12 is a front view of the cleat of FIG. 11 installed on a frame according to an embodiment of the present disclosure;

FIG. 13 is a cross-sectional view of the cleat and frame taken alone line 13-13 of FIG. 12, as mounted to a structure;

FIG. 14 is a front perspective view of a frame-to-frame connector according to an embodiment of the present disclosure;

FIG. 15 is a rear perspective view of the frame-to-frame connector of FIG. 14;

FIG. 16 is a cross-sectional view of the frame connector of FIGS. 14 and 15 joining two adjacent frame members;

FIG. 17 is an exploded perspective view of another cleat or hanger connector and a corresponding frame member according to an embodiment of the present disclosure;

FIG. 18 is a perspective view of a portion of a fastener useful for securing connectors according to embodiments of the present disclosure to frame members;

FIG. 19 is a cross-sectional view of the cleat and frame of FIG. 17 mounted to a structure;

FIG. 20 is an exploded perspective view of another frame-to-frame connector and corresponding frame members according to an embodiment of the present disclosure;

FIG. 21 is a cross-sectional view of the connector and frame members of FIG. 20 in an assembled state;

FIG. 22 is an exploded perspective view of another frame-to-frame connector and corresponding frame members according to an embodiment of the present disclosure;

FIG. 23 is a perspective view of another fastener useful for securing connectors according to embodiments of the present disclosure to frame members;

FIG. 24 is a cross-sectional view of the connector and frame members of FIG. 22 in an assembled state;

FIG. 25 is a perspective view of another assembled panel system according to an embodiment of the present disclosure;

FIG. 26 is perspective view of the panel system of FIG. 25, with the exterior panels removed to reveal a corresponding frame assembly;

FIG. 27 is a perspective view of a frame assembly including border connectors according to an embodiment of the present disclosure;

FIG. 28 is a perspective view of the frame assembly of FIG. 27, with an exterior panel installed thereon;

FIG. 29 is a perspective view of the frame assembly of FIGS. 27 and 28, with border members partially installed thereon;

FIG. 30 is a partial cross-sectional view of the frame assembly of FIG. 29 taken along line 30-30;

FIG. 31 is an exploded front view of a border connector according to an embodiment of the present disclosure;

FIG. 32 is an assembled rear view of the border connector of FIG. 31;

FIGS. 33-35 are rear views of a plurality of distinct borders connectable to frame assemblies of the present disclosure;

FIG. 36 is a front perspective view of a panel system including borders fitted between adjacent panels according to an embodiment of the present disclosure;

FIG. 37 is a perspective view of the panel system of FIG. 36 with a portion of the borders removed;

FIG. 38 is a perspective view of the panel system of FIG. 36 with the exterior panels and borders removed to reveal a corresponding frame assembly;

FIG. 39 is a front perspective view of a frame-to-frame connector according to another embodiment of the present disclosure;

FIG. 40 is a rear perspective view of the connector of FIG. 39;

FIG. 41 is a cross-sectional view taken alone line 41-41 of the connector of FIG. 39;

FIG. 42 is a cross-sectional view of the connector of FIG. 39 and corresponding frame members in an assembled state;

FIG. 43 is a perspective view of another panel system according to an embodiment of the present disclosure;

FIG. 44 is an exploded view of the panel system of FIG. 43;

FIG. 45 is a front perspective view of a frame-to-frame connector according to another embodiment of the present disclosure as shown in FIG. 44;

FIG. 46 is a rear perspective view of the connector of FIG. 45;

FIG. 47 is a cross-sectional view of the connector of FIGS. 45 and 46 and corresponding frame members in an assembled state; and

FIG. 48 is a front perspective view of a frame-to-frame connector according to another embodiment of the present disclosure as shown.

FIG. 49 is a front, top, left view of another embodiment of the invention;

FIG. 50 is a front, top, left view of the invention of FIG. 49;

FIG. 51 is an expanded front, top, left view of the invention of FIG. 50;

FIG. 52 is an expanded front, top, left view of the invention of FIG. 52;

FIG. 53 is an expanded front, top, left view of the invention of FIG. 52;

FIG. 54 is an expanded front, top, left view of the invention of FIG. 53;

FIG. 55 is a front view of the invention of FIG. 54;

FIG. 56 is a side view of the invention of FIG. 55;

FIG. 57 is an enlarged view of the invention of FIG. 56;

FIG. 58 is a cross-sectional view of the invention of FIG. 57;

FIG. 59 is an enlarged view of the invention of FIG. 58;

FIG. 60 is a cross-sectional view of the invention of FIG. 59;

FIG. 61 is an expanded view of the invention of FIG. 60;

FIG. 62 is an enlarged view of the invention of FIG. 61;

FIG. 63 is a left side cross-sectional view of the invention of FIG. 62;

FIG. 64 is a left side cross-sectional view of the invention of FIG. 63;

FIG. 65 is a left side cross-sectional view of the invention of FIG. 64;

FIG. 66 is a front, top, right side view of the invention of FIG. 65;

FIG. 67 is a front view of the invention of FIG. 66;

FIG. 68 is another embodiment of the invention of FIG. 67;

FIG. 69 is a front, top, left view of the invention of FIG. 68;

FIG. 70 is a front, top, right view of the invention of FIG. 69;

FIG. 71 is a cross-sectional view of the invention of FIG. 70;

FIG. 72 is a front, top, left view of the invention of FIG. 71;

FIG. 73 is an expanded view of the invention of FIG. 72;

FIG. 74 is a front, top, left view of the invention of FIG. 73;

FIG. 75 is another embodiment of the invention of FIG. 74;

FIG. 76 is a left side view of the invention of FIG. 75;

FIG. 77 is a cross-sectional view of the invention of FIG. 76;

FIG. 78 is a cross-sectional view of the invention of FIG. 77;

FIG. 79 is a cross-sectional view of the invention of FIG. 78;

FIG. 80 is a front view of the invention of FIG. 79;

FIG. 81 is an enlarged view of the invention of FIG. 80; and

FIG. 82 is another embodiment of the invention of FIG. 81.

### DETAILED DESCRIPTION OF THE EMBODIMENTS

It is to be understood that the figures and descriptions of the present invention have been simplified to illustrate elements that are relevant for a clear understanding of the present invention, while eliminating, for purposes of clarity, many other elements found in, for example, known systems. However, for sake of brevity and because such elements are well known in the art, and they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

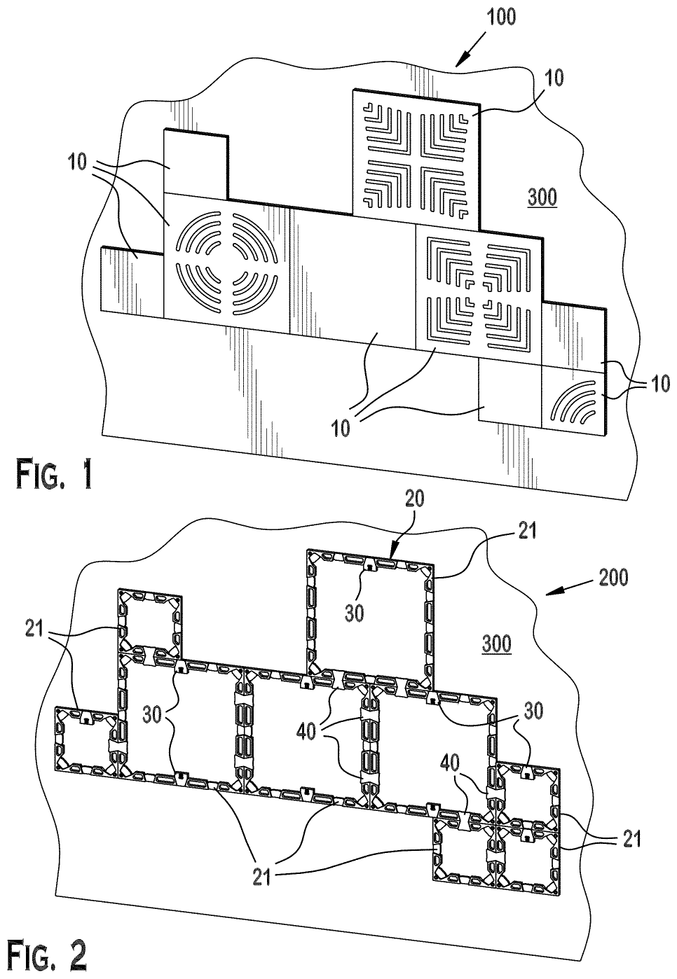

Embodiments of the present disclosure include modular panel display systems utilizing common or modular connectors having, for example, bow-tie, butterfly, dovetail, or halving joint features. The systems further utilize common fasteners throughout, including push-pin, expanding rivet, and/or ball and socket-type fasteners. Common connector profiles and shared fasteners facilitate the expedient joining of the system components, including the frames, panels, borders and mounting components. As shown in FIG. 1, an exemplary modular panel system or assembly 100 according to embodiments of the present disclosure is shown. The assembly 100 includes an arrangement of interconnected panels 10, which may be decorative and/or functional in nature and may be secured to a mounting surface 300, such as a wall. The panels 10 may varying in number, size, shape and/or exterior appearance, and may be assembled together in any desired configuration depending on the application, including functional and/or artistic design considerations.

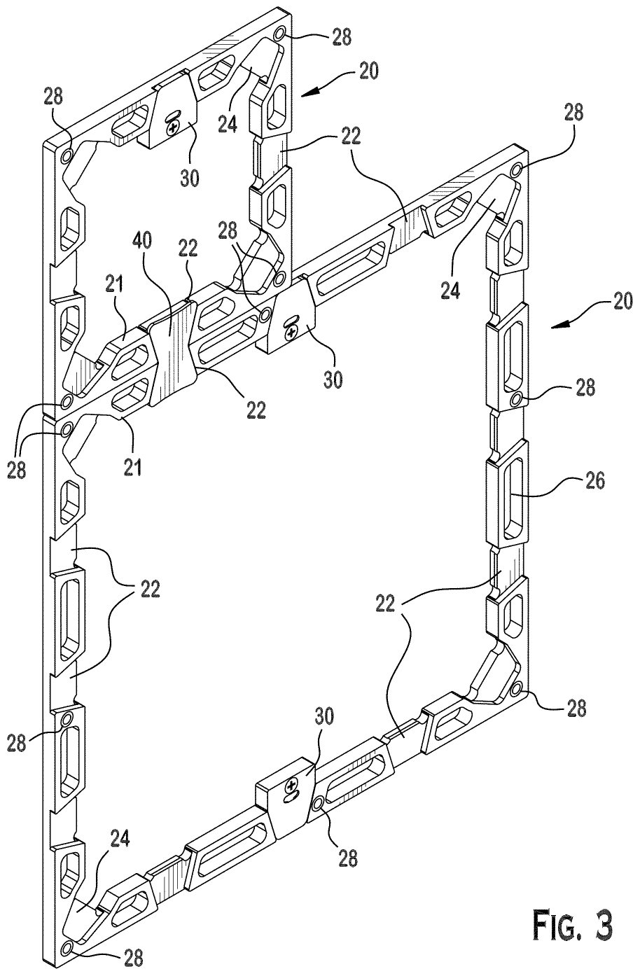

FIG. 2 illustrates the panel assembly 100 of FIG. 1, with the panels 10 removed to reveal a frame assembly 200. The frame assembly 200 includes a plurality of interconnected frames 20, with each frame corresponding in size to one of the plurality of panels 10. Each frame may include a monolithic frame, in the illustrated exemplary embodiment, a monolithic polygon having a plurality (e.g., four) of sides, sidewalls or frame members 21 integrally formed with one another. In other embodiments, one or more sidewalls 21 of a frame 20 may include a discrete element mechanically fastened to one or more additional sidewalls to form the illustrated four-sided frames without departing from the scope of the present disclosure. With reference to FIGS. 2 and 3, each frame 20 may be connected to an adjacent frame via one or more frame-to-frame connectors or frame connectors 40. More specifically, adjacent or neighboring sidewalls 21 of each frame 20 are fixed to one another via the frame connector 40, with the frame connector fitted into opposing, correspondingly-sized first connector receiving sections 22 defined in each sidewall 21.

A cleat or hanger connector 30 may also be fitted to one or more of the connector receiving sections 22, and is configured to enable mounting of the frame 20 to, for example, a wall as will be set forth in further detail herein. As shown in the figures, each of the receiving sections 22 includes a standard size, and accepts multiple different types of connectors for providing maximum flexibility and configurability to the system. More specifically, each receiving section 22 may define a standard-sized recess formed into a top or front surface of the frame 20. The receiving sections 22 extend in a tapered manner through an entirety of a width of the sidewall 21 and in a direction from an interior of the frame to an exterior of the frame.

Each frame 20 further defines at least one panel connector 28, such as a receiving cup or socket fitted within a corresponding aperture formed in the frame 20, for removably connecting to a corresponding connector of a given panel 10 to be attached to the frame. In the exemplary embodiment, each frame 20 include a panel connector 28 arranged in each corner thereof. In other embodiments, additional panel connectors 28 may be arranged between the corners of the frame 20, and generally along one or more of the sidewalls 21 (e.g., in a middle section thereof). Second receiving sections 24 are defined in the corners of each frame 20, and are oriented in an angled manner with respect to adjacent sidewalls 21 of the frame 20. In particular, the receiving sections 24 are oriented such that their longitudinal axes generally bisect the right angle defined by the illustrated orthogonally-arranged sidewalls 21 of the frame. Still referring to FIGS. 2 and 3, the frames 20 may include a square frame of a first size and a square frame of a second size, with the second size being one-quarter that of the first size in planar area such that four interconnected frames of the second size are equal in size to a single frame of the first size. Each frame 20 further includes a plurality of openings 26 formed through each sidewall 21 thereof, reducing the overall weight of the frame.

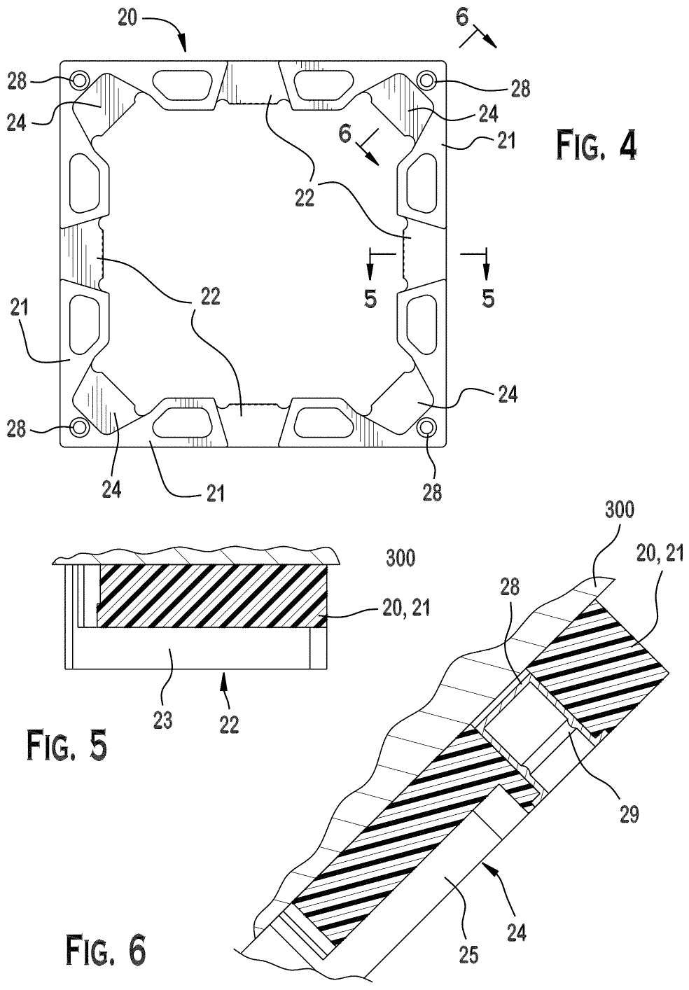

FIGS. 4-6 illustrates the frame 20 of the second or smaller size in isolation. As shown in FIG. 4 and the cross-section 5-5 of FIG. 5, the receiving section 22 defines a recess 23 formed partially into the sidewall 21 to a first depth from a front surface thereof, with the recess extending in a tapered manner through an entire width of the sidewall 21. As shown in FIG. 4 and the cross-section 6-6 of FIG. 6, the second receiving section 24 defines a recess 25 having similar tapered profile to that of the recess 23. However, the recess 25 extends from an interior of the sidewalls(s) 21 outwardly through the sidewall to a point adjacent the panel connector 28, rather than entirely through the width of the sidewall(s) 21. Still referring to FIG. 6, the panel connector 28 defines an aperture including an annular locking protrusion 29 extending radially inward into the aperture. The panel connector 28 may include an aperture formed directly into the sidewall 21, or may include a separate cup or socket received within an aperture formed in the sidewall 21.

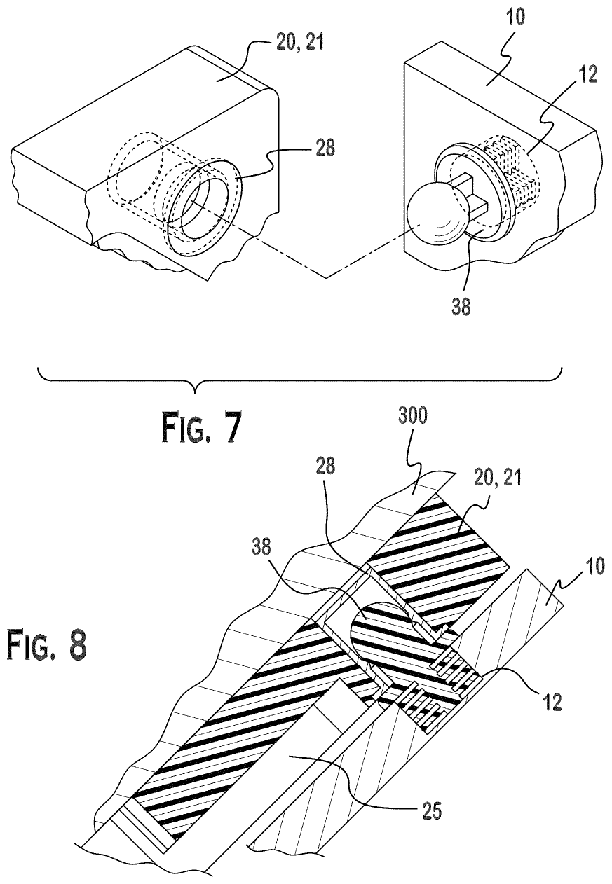

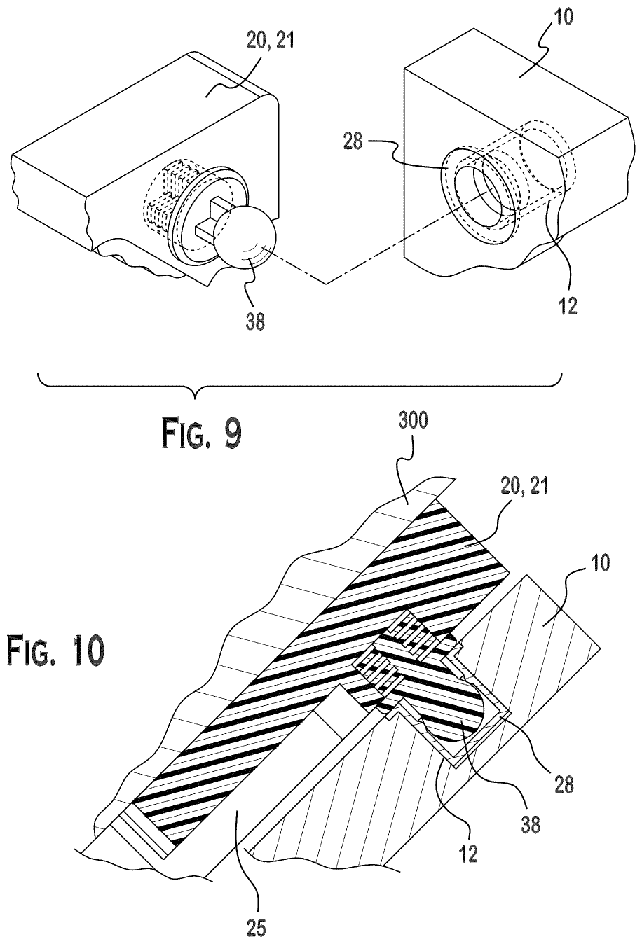

FIGS. 7 and 8 illustrate the frame 20 fitted with the panel connector 28, and a corresponding panel 10 fitted with a complementary panel connector 38. The panel connector 38 includes a ball-like protrusion configured to be received within the panel connector 28 in a snap-fit manner, thereby defining a spherical detent arrangement, as shown in FIG. 8. Once inserted, the protrusion maybe retained within the aperture of the panel connector 28 via the annular locking protrusion 29. An end of the panel connector 38 opposite the ball-like protrusion may define a plurality of radially extending elastic elements which may be press-fit into a corresponding aperture 12 of the panel 10, securing the panel connector 38 therein. Referring to FIGS. 9 and 10, the opposite arrangement to that of FIGS. 7 and 8 is shown, with the ball-like panel connector 38 fitted to the frame 20, and the receiving or female panel connector 28 defined by, or press-fit into, the panel 10.

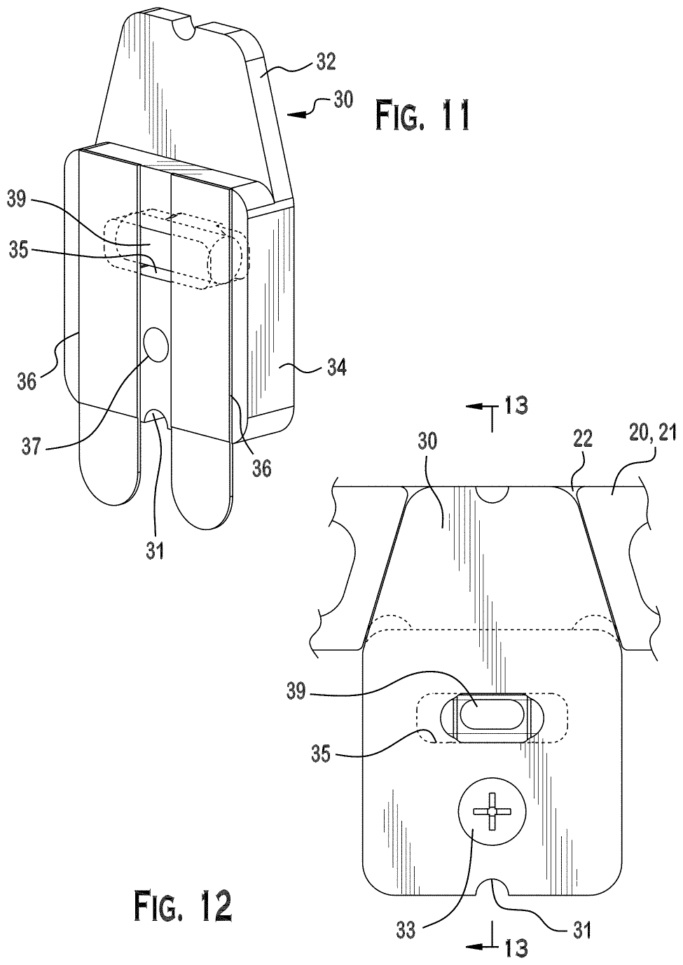

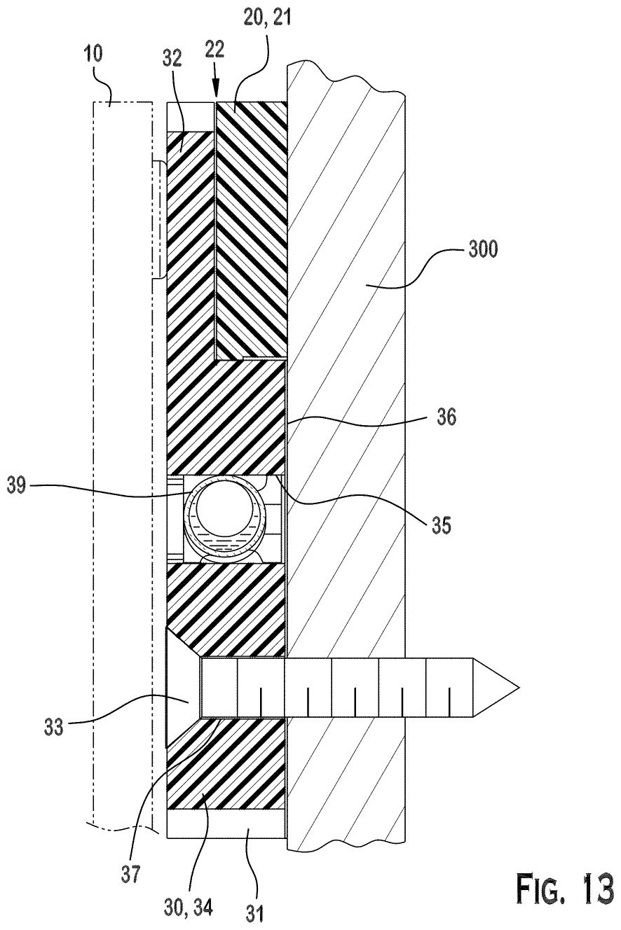

With reference to FIGS. 11-13, the cleat or hanger connector 30 according to an embodiment of the present disclosure includes a “half bow-tie” shaped mating portion 32 having a thickness and taper matching that of the receiving sections 22,24 into which it is adapted to be received. The cleat 30 further defines a mounting portion 34 having a thickness greater than that of the mating portion 32 and approximately equal to that of the frame 20 in an area outside of the receiving section 22,24. In this way, as shown in FIG. 13, a side of the mounting portion 34 of the cleat 30 is sized to be flush with the mounting surface 300. In the illustrated embodiment, the taper of the mating portion 32 generally narrows in a direction away from the mounting portion 34, and thus, the mounting portion is arranged within an interior of the frame 20. In other embodiments, the direction of the taper may be reversed, such that the mounting portion 34 is arranged on an exterior side of the frame 20 given the illustrated orientation of the receiving sections 22.

The mounting portion 34 further defines a through-hole 37 into which a fastener 33, such as a screw, may be passed for securing the cleat 30, and thus the panel(s) 20 associated therewith, to the mounting surface 300. The through-hole 37 may include a counter-sink or a counter-bore defined in the mounting portion 34 for recessing the head of the fastener 33, ensuring a panel 10 may be fitted thereover without interference, as shown in FIG. 13. The exemplary mounting portion 34 further includes a secondary aperture 35 which may be slotted in profile for receiving, for example, a cylindrical, fluid-filled vial, or bubble level 39, for aiding in accurately positioning the panel(s) 20. Moreover, the side of the mounting portion 34 facing the mounting surface 300 may be generally planar in profile, and defines a mounting surface to which a plurality of hook and loop and/or double-sided adhesive tabs or strips 36 may be applied or secured thereto for attaching the cleat 30 to the mounting surface. The use of adhesive strips 36 avoids permanent damage or unnecessary markings to the mounting surface 300, and enables tool-less mounting of the panel assembly 100. A notch 31 may be defined in the end of the mounting portion 34, and generally centered along its width. The notch 31 may define a mounting recess for engaging with a fastener for hanging the cleat, and/or for indicating the approximate placement location of the adhesive strips 36.

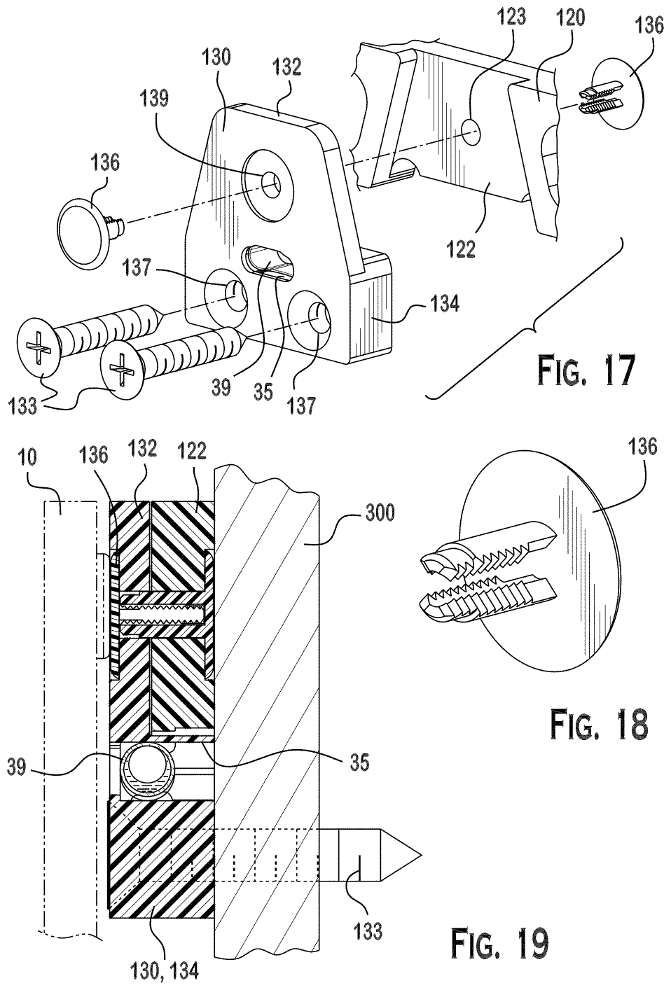

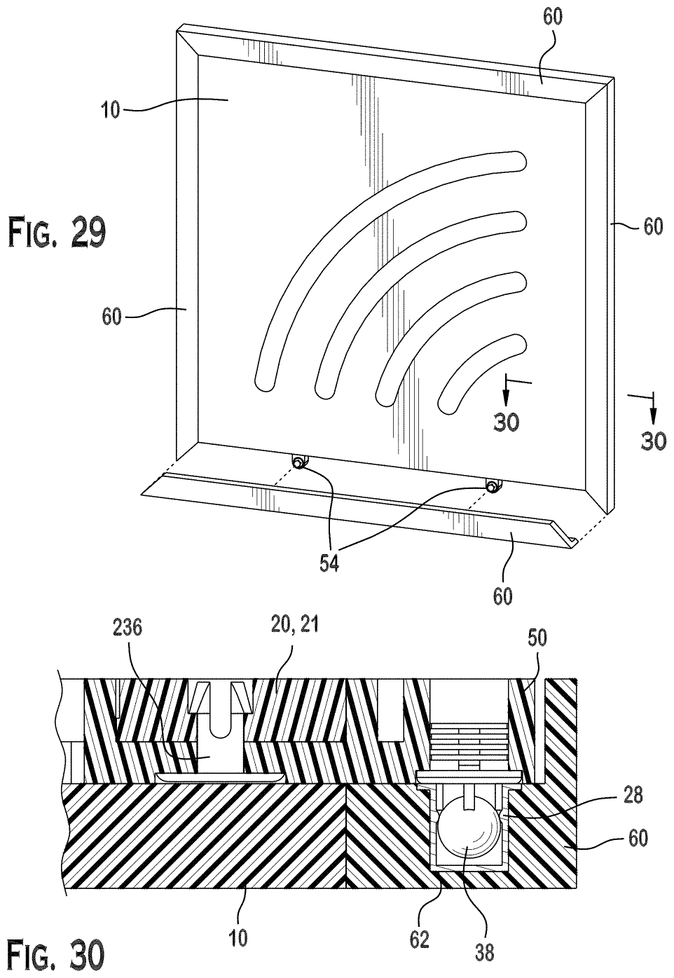

FIGS. 17-19 illustrate another embodiment of a cleat of hanger connector 130, wherein a pair of through-holes 137 are formed in a mounting portion 134 thereof for utilizing two corresponding fasteners 133 for securing the frame 20 to the mounting surface 300. Each mating portion 132 defines a through-hole 139 through which one-half of a fastener 136 is passed. A corresponding other half of the fastener 136 is passed through a corresponding through-hole 123 formed in a receiving section 122 of a frame 120, wherein securing the halves of the fastener(s) 136 together via the complementary ridged or toothed surfaces thereof positively attaches the cleat 130 to the frame 120. As shown in FIGS. 25 and 26, the above-described hanger 130 has been inserted into a corner, angled receiving section 24 of each of the two interconnected frames 20, thereby defining two mounting locations for fixing the frame assembly in a like-wise angled orientation (i.e., 45 degrees offset from vertical or horizontal) on the mounting surface 300.

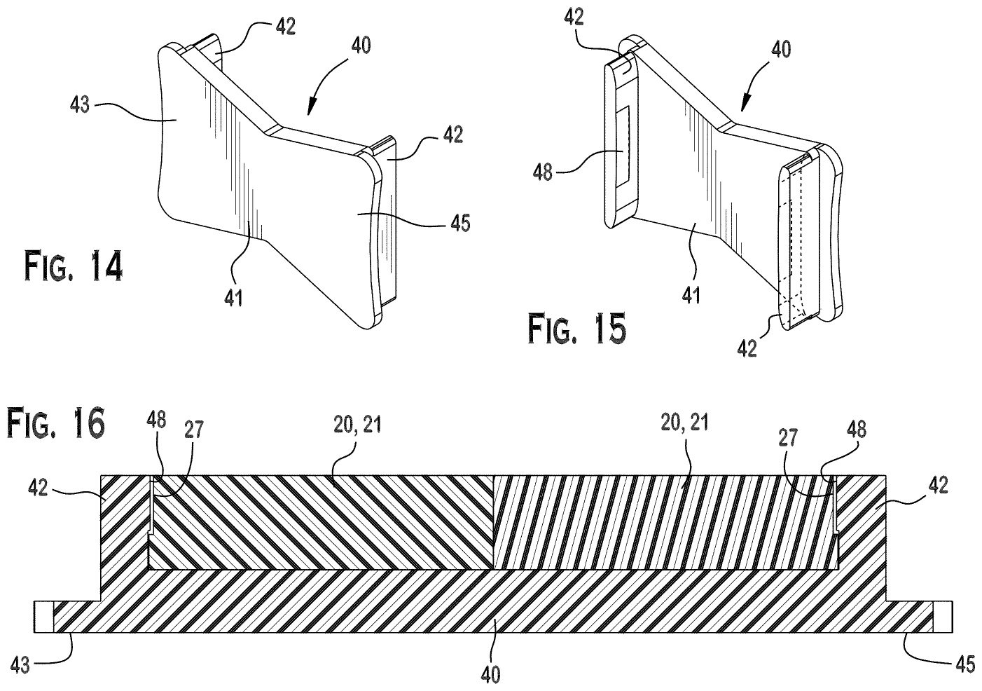

FIGS. 14-16 illustrate the frame-to-frame connector 40 in greater detail, including a center body section 41 defining a generally “bow-tie” shape, with each side 43,45 thereof having a dovetail a profile tapering or narrowing toward one another in an opposing manner. The body section 41 is sized and shaped so as to fit into abutting receiving sections 22 of adjacent frames 20, securing them together in the illustrated “key-fit” manner (see FIG. 3). The body section 41 further includes protruding legs or ribs 42 extending in a direction transverse to the longitudinal direction of the body and are adapted to abut respective interior sides of the frame 20, capturing the sidewalls/receiving sections 22 of each frame therebetween. Each leg 42 may further define a protruding surface (or a recess) 48 configured to engage with a corresponding recess 27 (or protrusion) formed on an interior surface of the frame 20 for providing a snap-fit connection of the connector 40 with each adjacent frame member 20, further fixing the connector 40 relative to the frames 20.

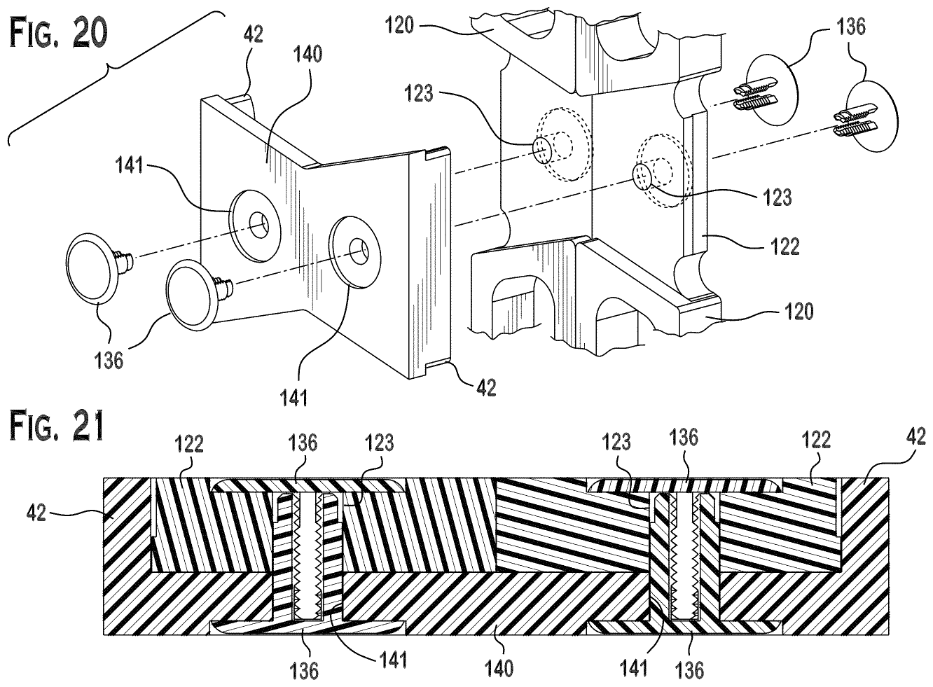

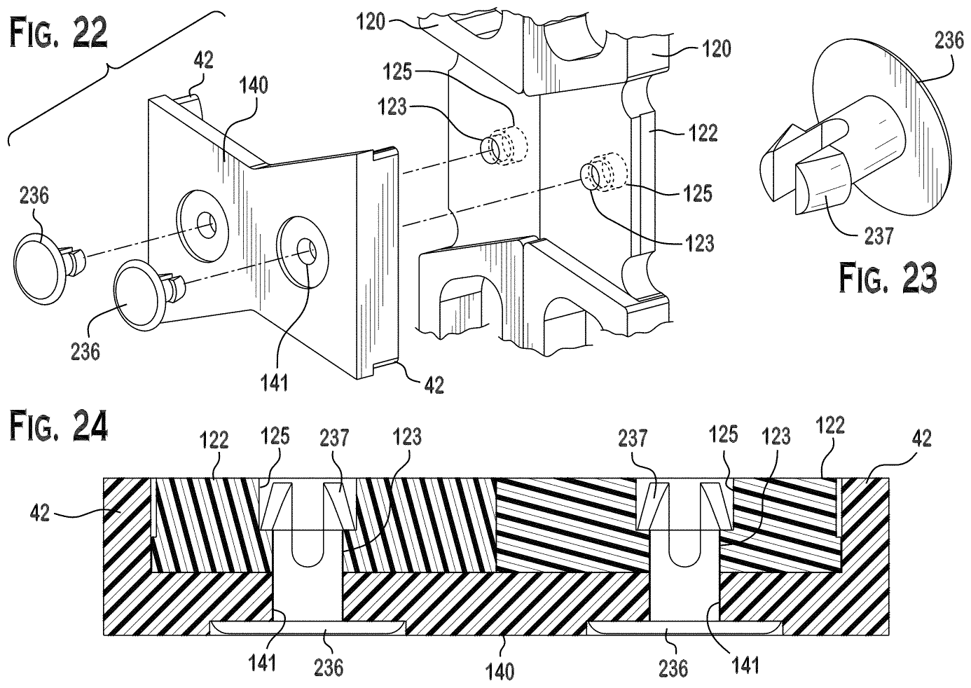

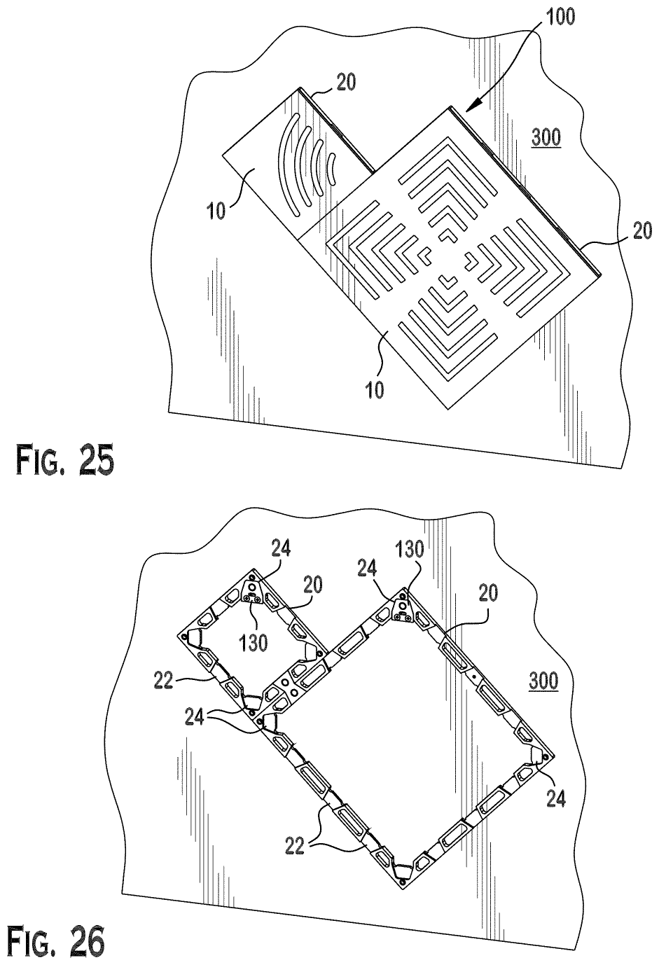

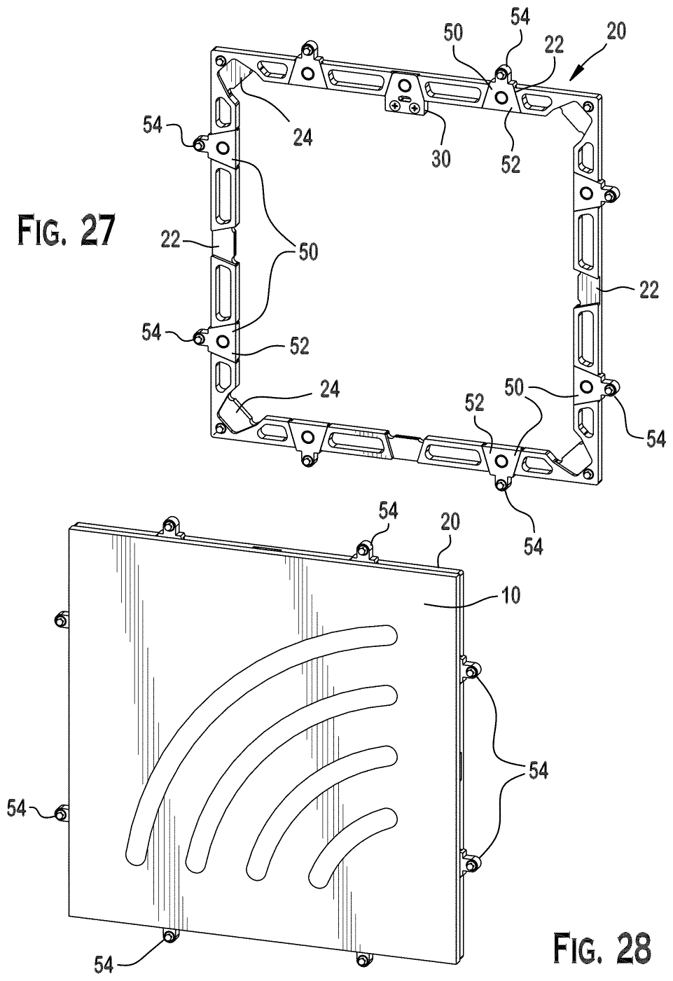

FIGS. 20 and 21 illustrate another embodiment of a frame-to-frame connector 140 which includes through-holes 141 formed therethrough for receiving one-half of the fastener 136. A corresponding other half of the fastener 136 is passed through each of the corresponding through-holes 123 formed in a frame 120 in the area of receiving sections 122 sections. Securing the halves of the fastener 136 together positively fastens the connector 140 to the adjacent frames 120. In the embodiment of FIGS. 22-24, the connector 140 receives two fasteners 236 therethrough for securing to the frames 120. Each fastener 236 includes a push-pin, or expanding rivet-type configuration, with an elastically deformable head portion 237 configured to engage with a corresponding recess or counterbore 125 defined by the through holes 123 formed in the frames 120. The fasteners 236 provides a snap-fit engagement with the frames 120, without requiring access to a back side thereof, as with the embodiments utilizing a two-part fastener.

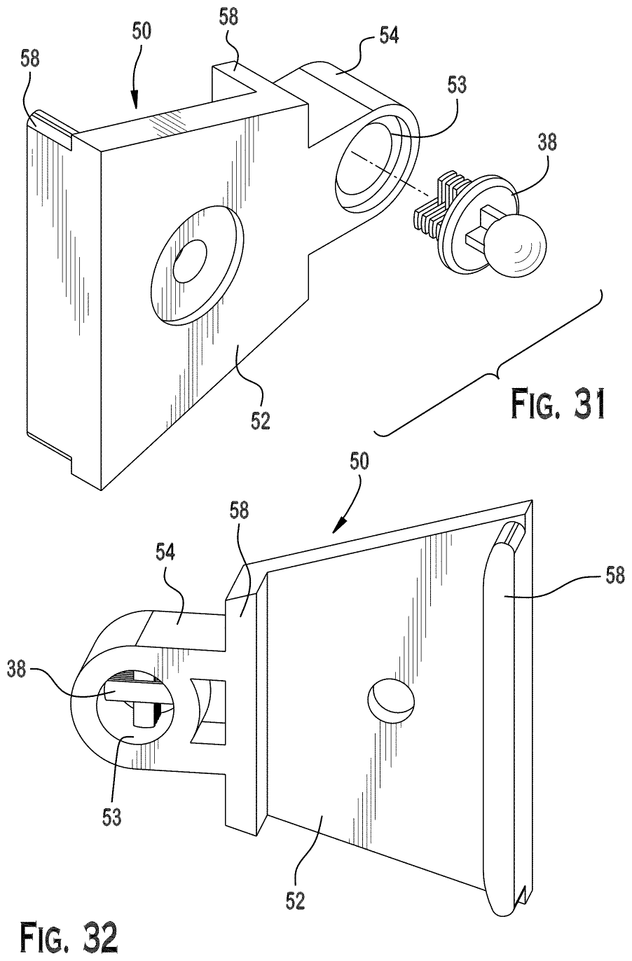

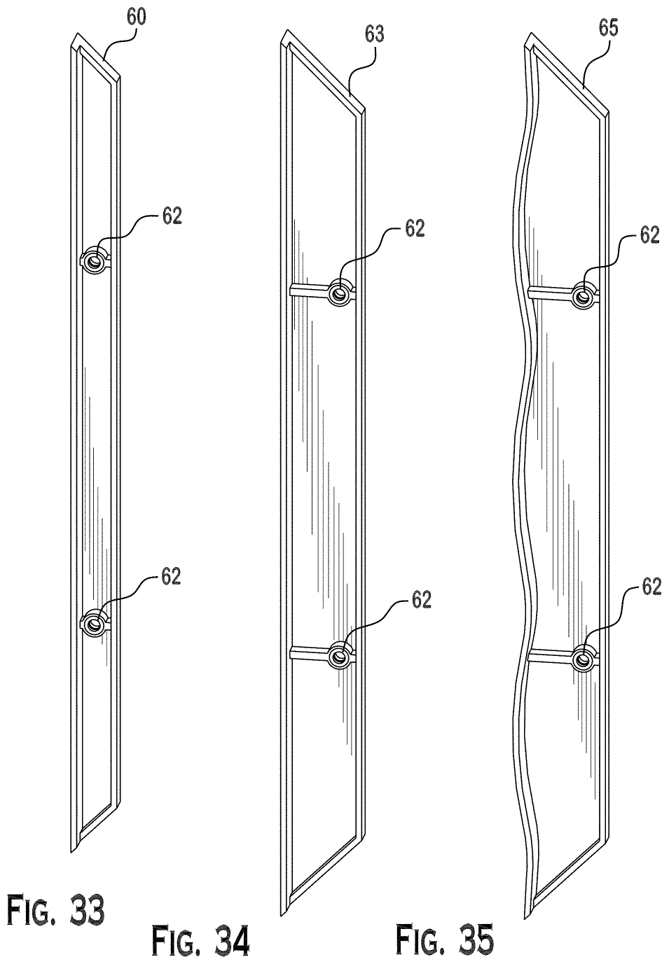

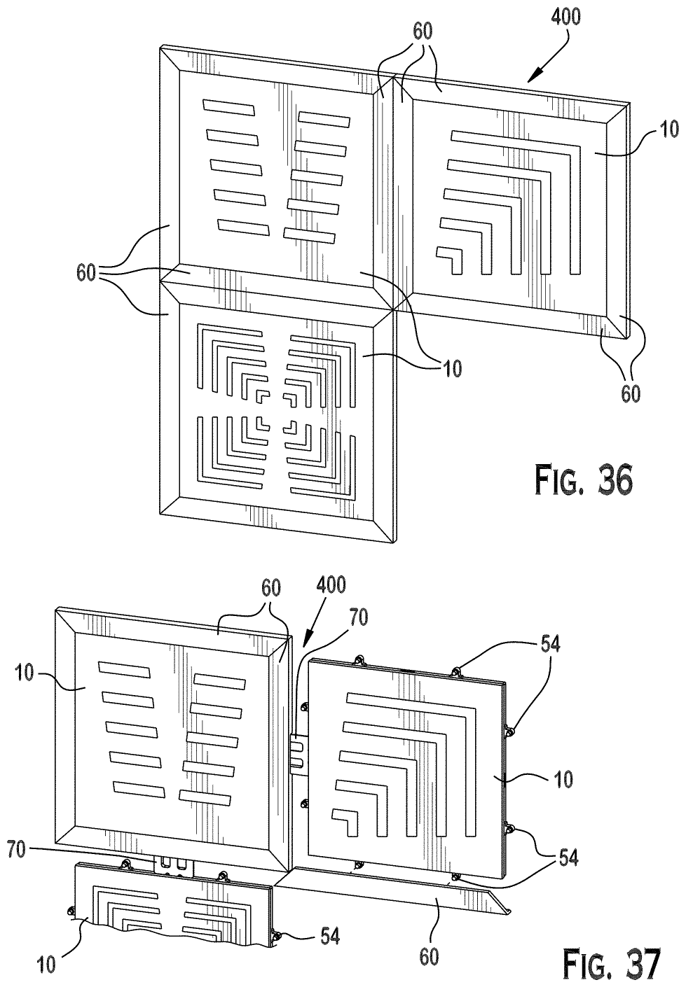

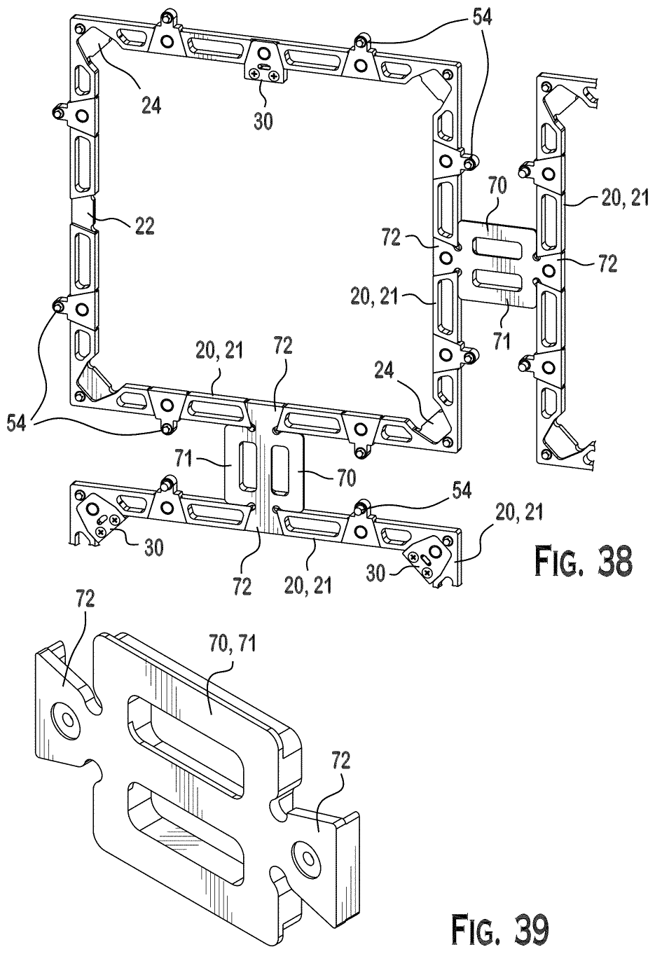

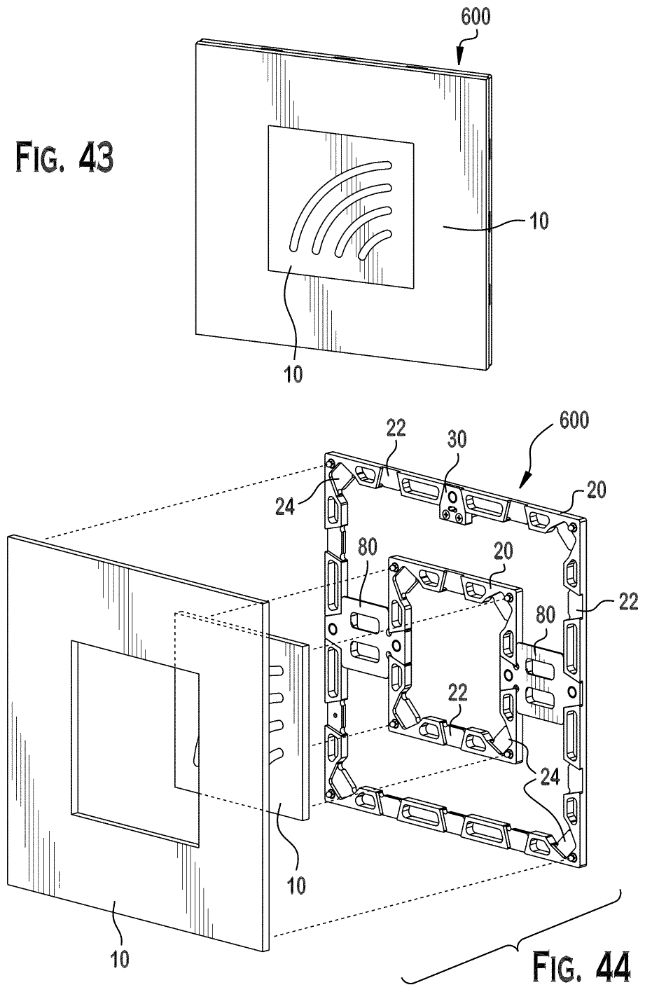

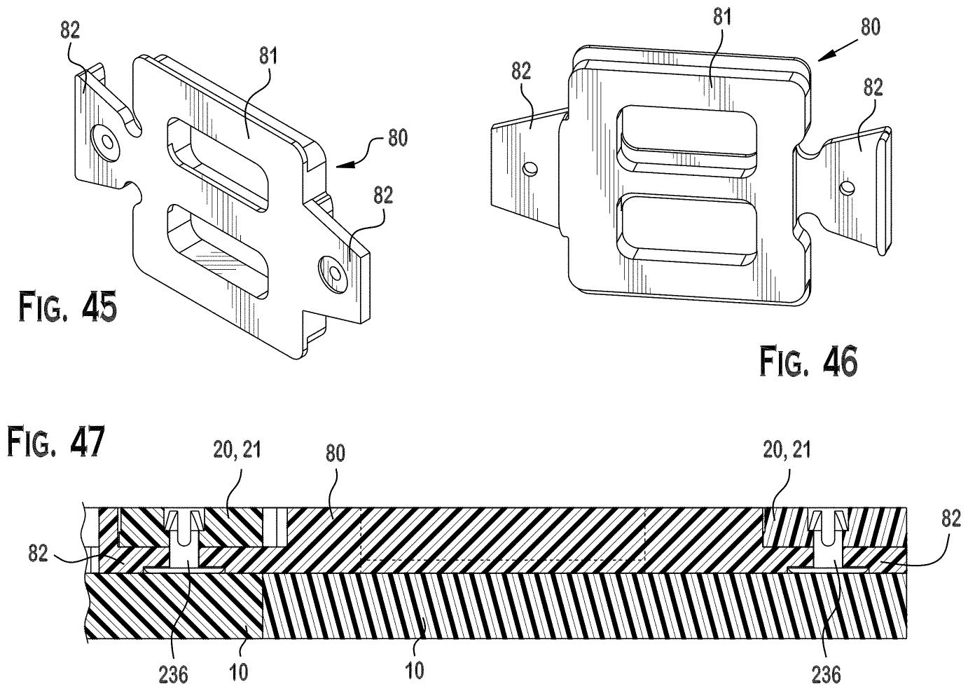

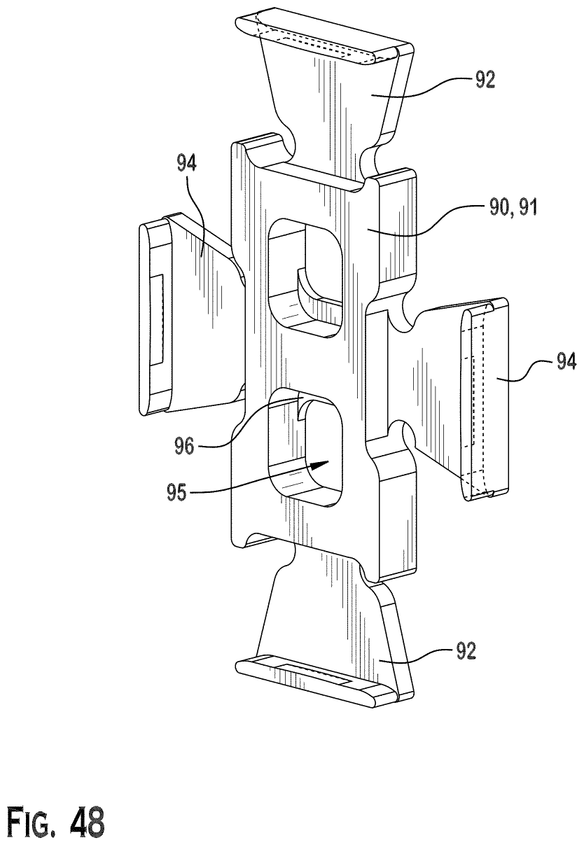

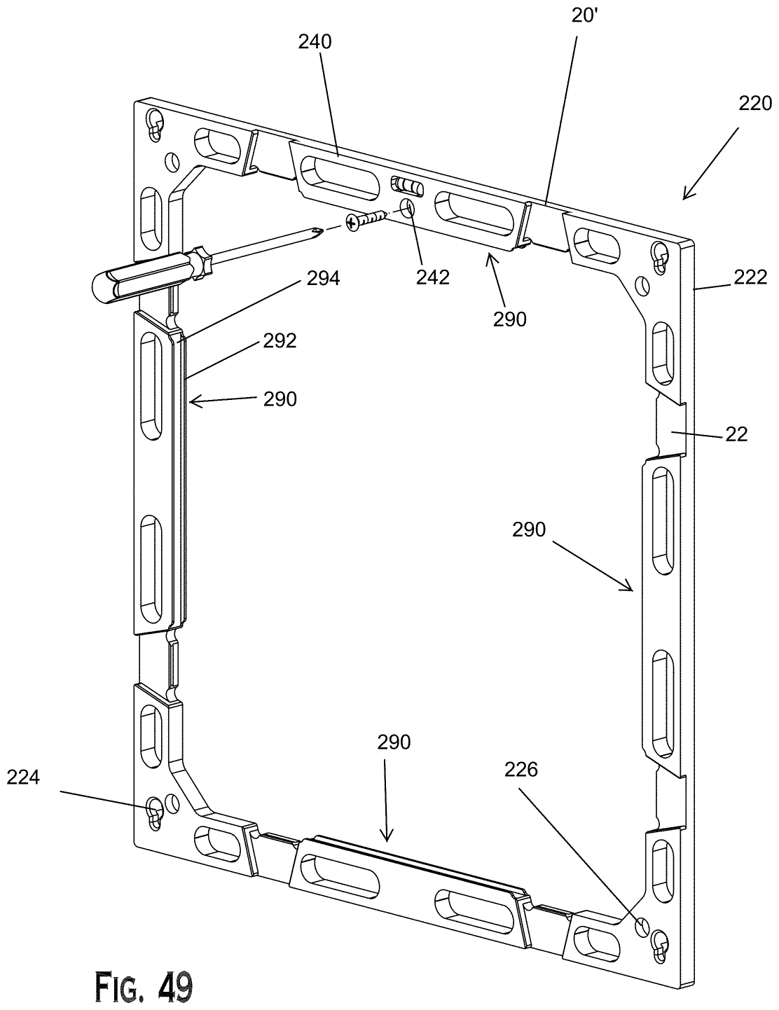

FIGS. 27-47 illustrate a border system according to embodiments of the present disclosure. Referring to FIG. 27, the exemplary frame 20 is shown with a plurality of border connectors 50 fitted thereto. Each border connector 50 includes a “half bow-tie” shaped mating portion 52 having a thickness and taper matching that of the receiving section 22 into which it is fit or received in the illustrated manner. See also FIGS. 31 and 32. Also shown in FIGS. 31 and 32, each border connector 50 may further include a pair of protruding legs 58, similar to those set forth with respect to FIGS. 14-16 for engaging with corresponding features of the frame 20 (e.g., notched sections thereof on an interior wall) for providing a snap-fit connection therebetween. The border connector 50 further defines a mounting portion 54 having a thickness greater than that of the mating portion 52, and approximately equal to that of a thickness of the frame 20. The mounting section 54 may define an aperture 53 configured to receive a male border fastener of connector 38 (as also shown in FIG. 7) therein for mating with a complementary female connector of a border element (or vice versa), such as a cup or socket 28 as shown in the previous embodiments. The border connector 50 may be secured to the frame 20 via fastening means, such as those set forth in FIG. 17-19 or 22-24, the details of which are not repeated herein for the purpose of brevity.

Referring to FIG. 28, a panel 10 is fitted over the frame 20, covering the mating portions 52 of each connector 50, while leaving the mounting portions 54 exposed for interfacing with and connecting to a plurality of border elements 60, as shown in FIG. 29. As will be understood for the figures, each border element 60 may define an aperture 62 formed on an underside thereof and adapted to receive the connector 28. The connector 38 and the connector 28 engage in a snap-fit manner, as described above with respect to FIGS. 7 and 8. The use of shared fasteners for securing both the panels 10 and the borders 60 to the frames 20 result in reduced system complexity and lower production costs. FIGS. 33-35 illustrate various border elements 60,63,65, with border element 63 having a thicker width compared to that of the border element 60, and the border element 65 having a non-linear exterior or external profile.

FIGS. 36-42 illustrate panel and frame assemblies which utilize an offsetting or spacing frame-to-frame connector or a temporary spacing tool in order to achieve separation between frames for accommodating, for example, border elements arranged therebetween. Specifically, the exemplary panel assembly 400 includes a plurality of interconnected panels 10, each having a border defined about is perimeter via a plurality of border elements 60, as shown in FIG. 36. With reference to FIG. 37, the border elements 60 associated with one of the panels 10 have been removed, revealing a spacer or offsetting frame-to-frame connector or spacing tool 70 according to embodiments of the present disclosure. As shown in greater detail in FIG. 38, the connector 70 includes opposingly-tapering mating portions 72 having features similar to those set forth above with respect to the frame-to-frame connectors 40. In distinction to the connecter 40, however, the connector 70 further includes a central body portion 71 arranged and extending between the mating portions 72, and creating an offset distance between interconnected sidewalls 21 of the frames 20. The connector 70 may be utilized temporarily as a removable installation tool for setting a correct spacing and orientation (i.e. parallel to one another) of the frames 20, wherein it is removed prior to the installation of the panels and/or border elements.

Likewise, the connector 70 may form part of the frame assembly, and remain installed ensuring proper spacing is maintained. As will be understood from the figures, the width of the central body portion 71 may corresponding to approximately double the width of each border element 60, such that the use of the connector 70 provides a gap between each frame 20 sized to accommodate two adjacent border elements 60.

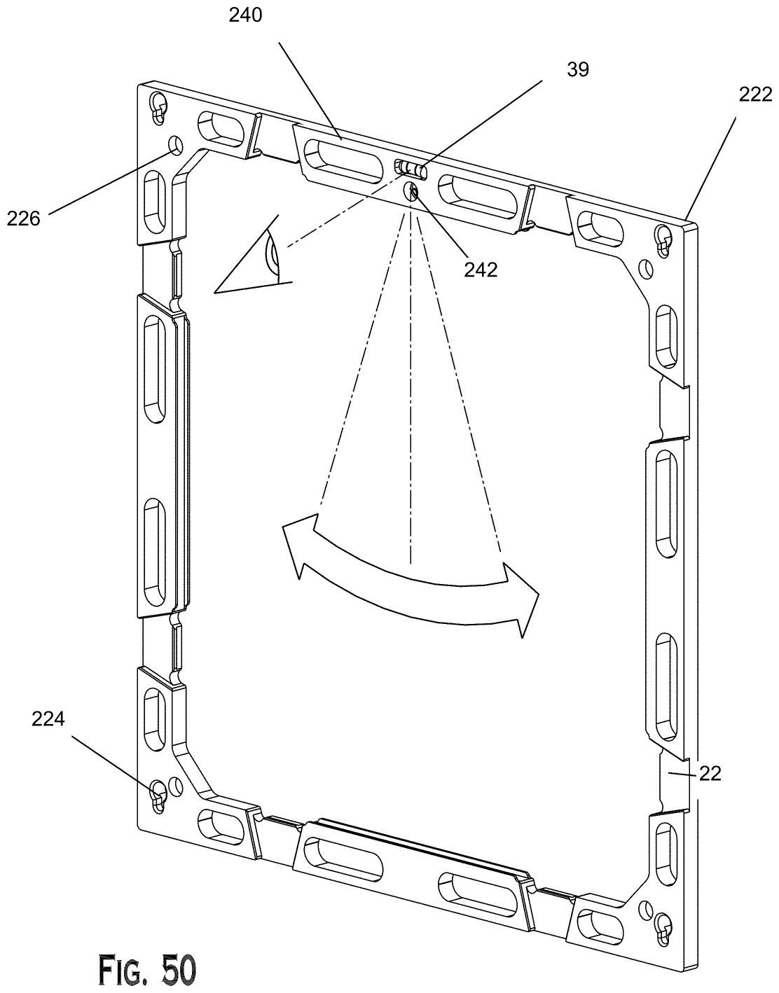

FIGS. 43-47 illustrate another embodiment of a panel assembly 600 according to the present disclosure including a first frame 20 mounted within a second frame 20, as distinct from adjacently mounted frames as shown in the preceding embodiments. This arrangement is achieved via an offsetting or spacing tool or frame-to-frame connector 80 according to another embodiment of the present disclosure. Using the connector 80, an outer panel 10 or border may be secured to the second frame 20, and a central panel 10 secured to the first frame 20, as shown in FIG. 44. The connector 80 includes a central body portion 81 similar to that of connector 70, as well as two tapered mating portions 82 arranged on opposite ends thereof. The mating portions 82 each taper in the same direction, as distinct from opposing directions as set forth with respect to the other frame-to-frame connectors described herein, such that they may be fitted to the receiving sections 22 of the frames 20 in the illustrated manner. Each of the connectors 70 and 80 and associated receiving sections 22 of the frames include features similar to those set forth above with respect to the preceding embodiments, as shown in the figures. Accordingly, repetitive detailed descriptions of these features are omitted herein.

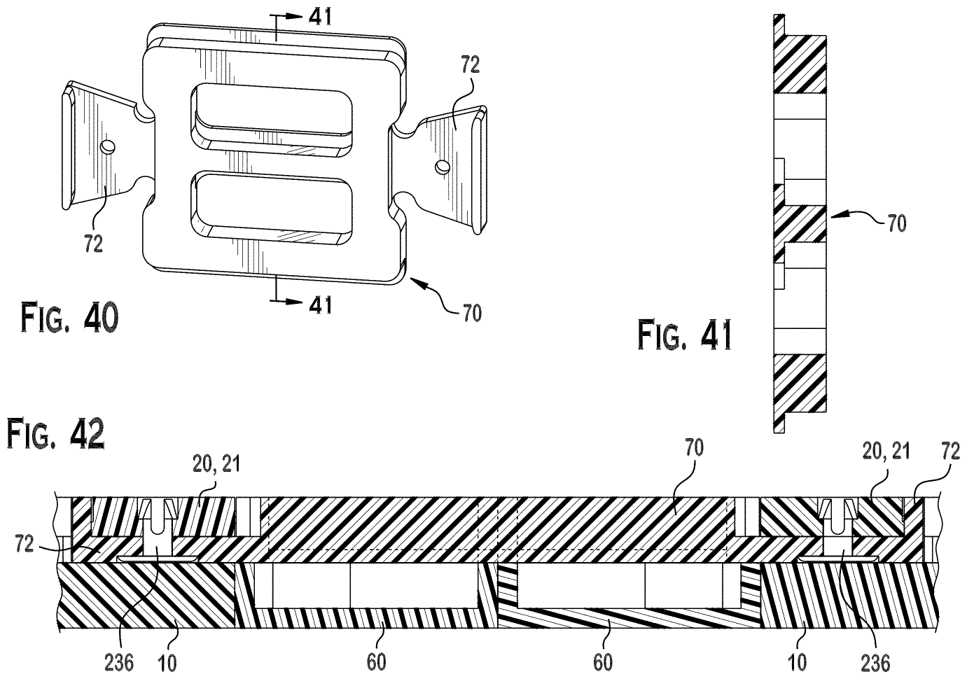

The connector or spacing tool 90 shown in FIG. 48 includes features similar to those set forth above with respect to FIGS. 39 and 40, for example. Specifically, the connector 90 comprises a body 91 having first and second mating portions 92 on opposite first sides thereof. The body 91 further includes a second set of mating portions 94, with each formed on opposite second elongated sides of the body 91. As shown in the figure, the first pair of mating portions 92 are spaced apart from one another at a first distance, and the second pair of mating portions 94 are spaced apart from one another by a second distance, less than the first distance as defined by the length and width of the body 91. As the spacing between the first mating portions 92 and the second mating portions 94 is different, the connector 90 may be used, for example, as a tool for setting the spacing between adjacent frames 20 at either one of the two distances. In this way, the connector 90 defines a multi-use tool, reducing a number of connectors (or tools) required to assemble a system according to embodiments of the present disclosure. Still referring to FIG. 48, a pair of openings 95 are define through the body 91, wherein the body further defines a lip or protrusion 96 extending into each opening 95 proximate an outwardly-facing side of the connector 90. The openings 95 and protrusions 96 define gripping surfaces configured to be engaged by, for example, the fingers of a user for enabling a firm grasp of the connector 90 during use.

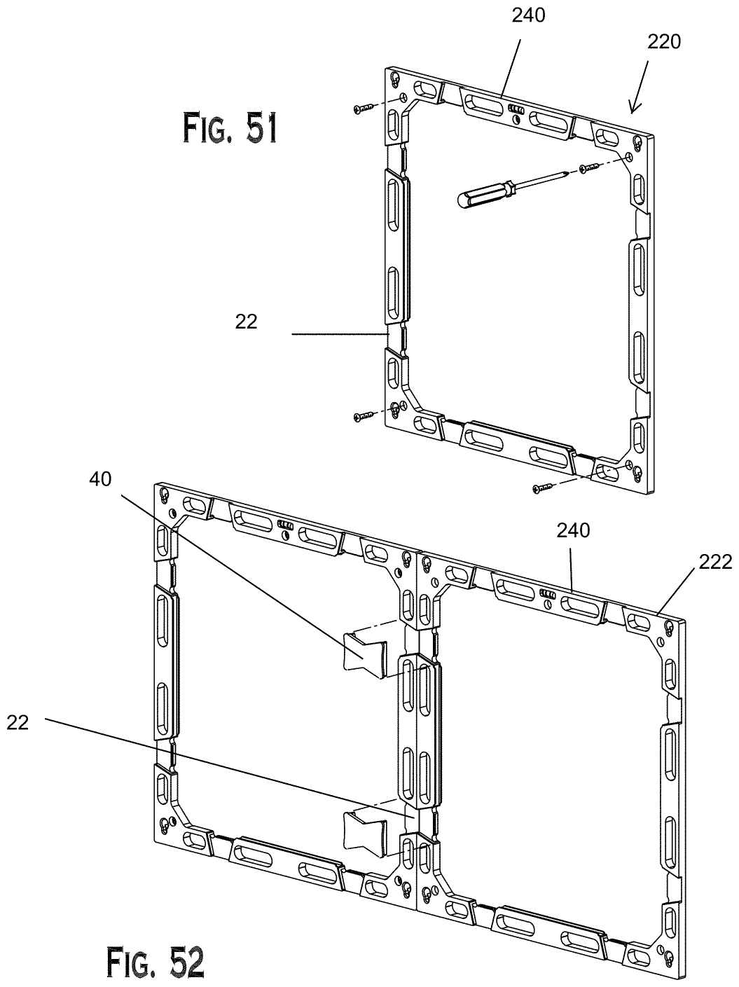

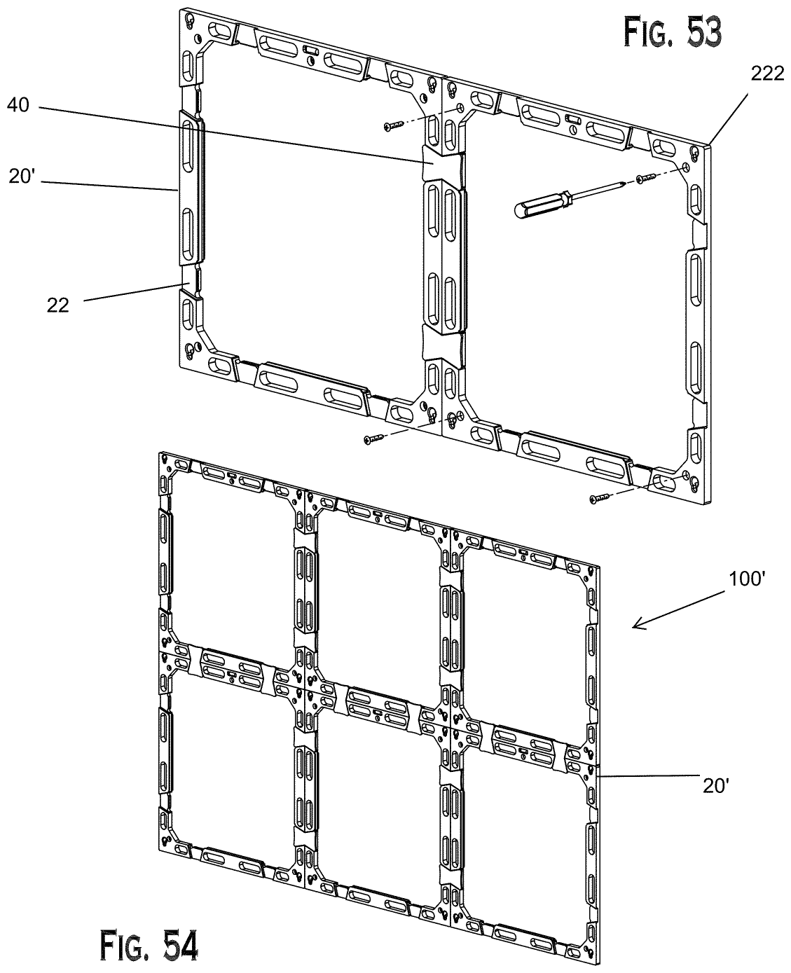

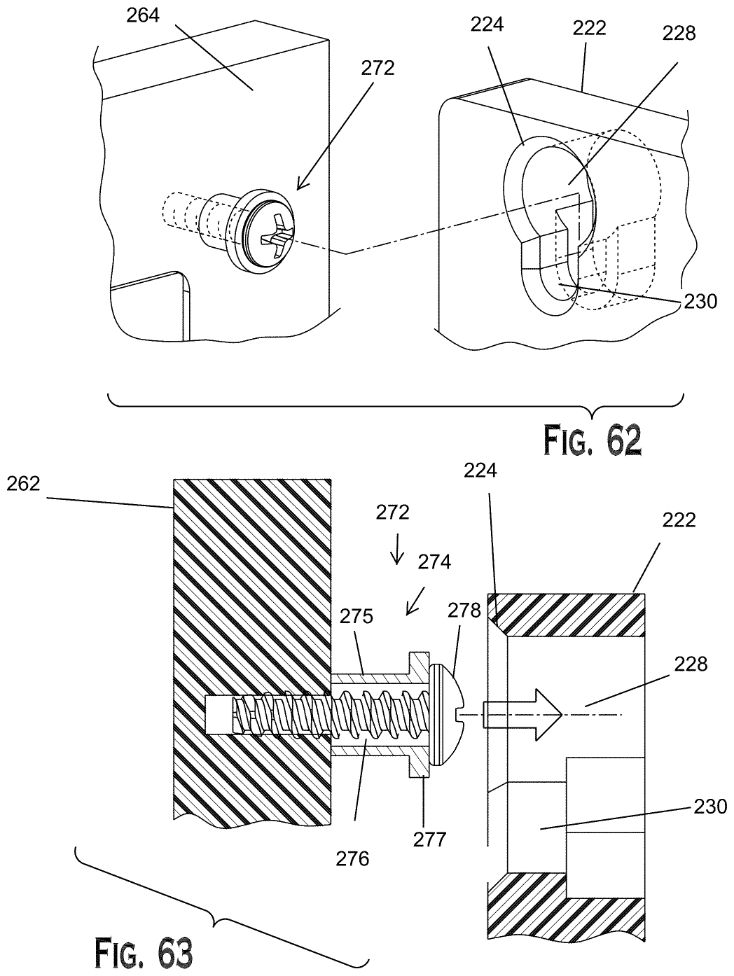

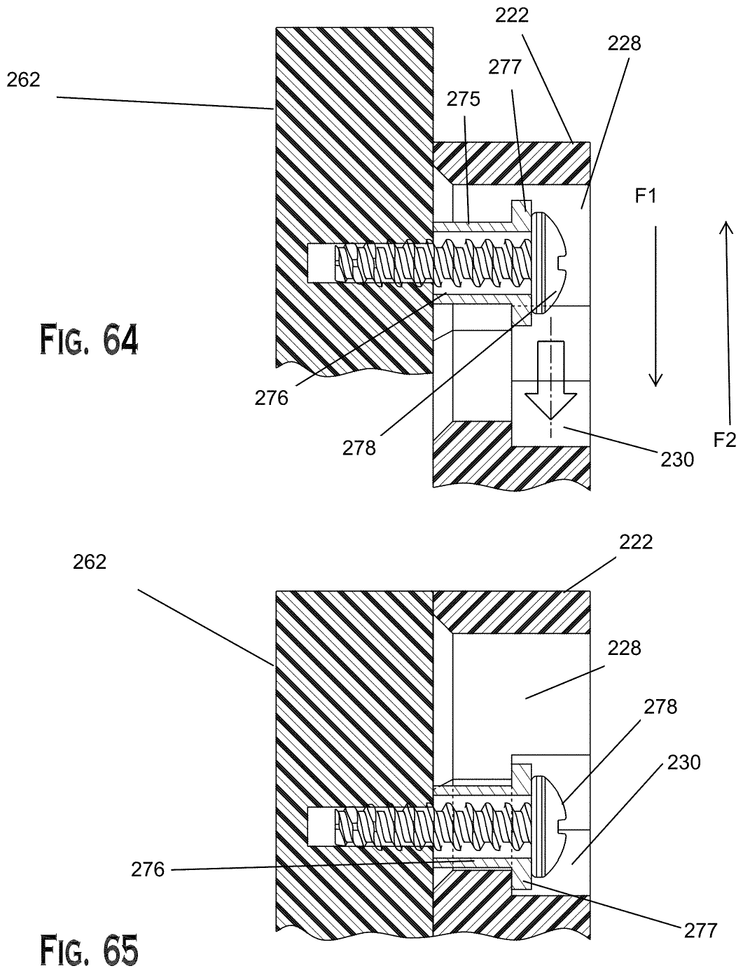

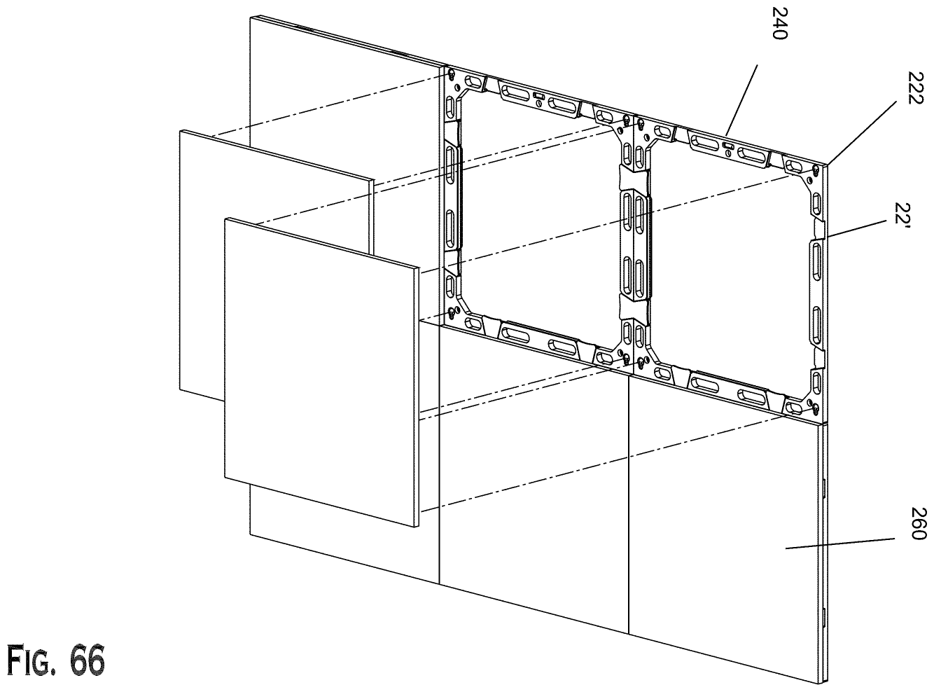

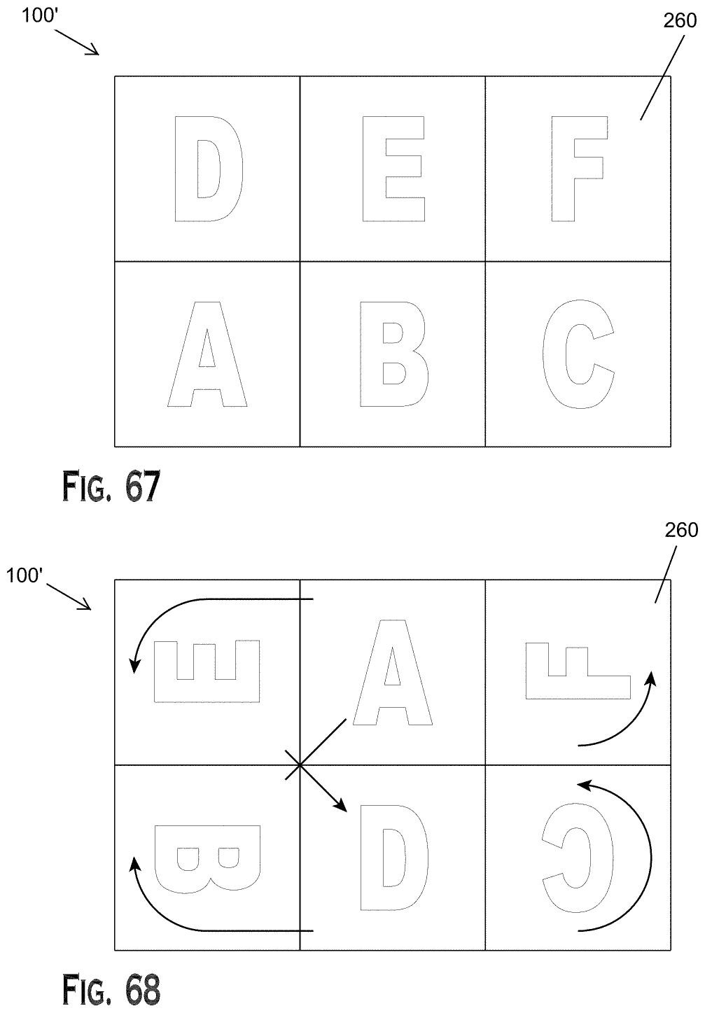

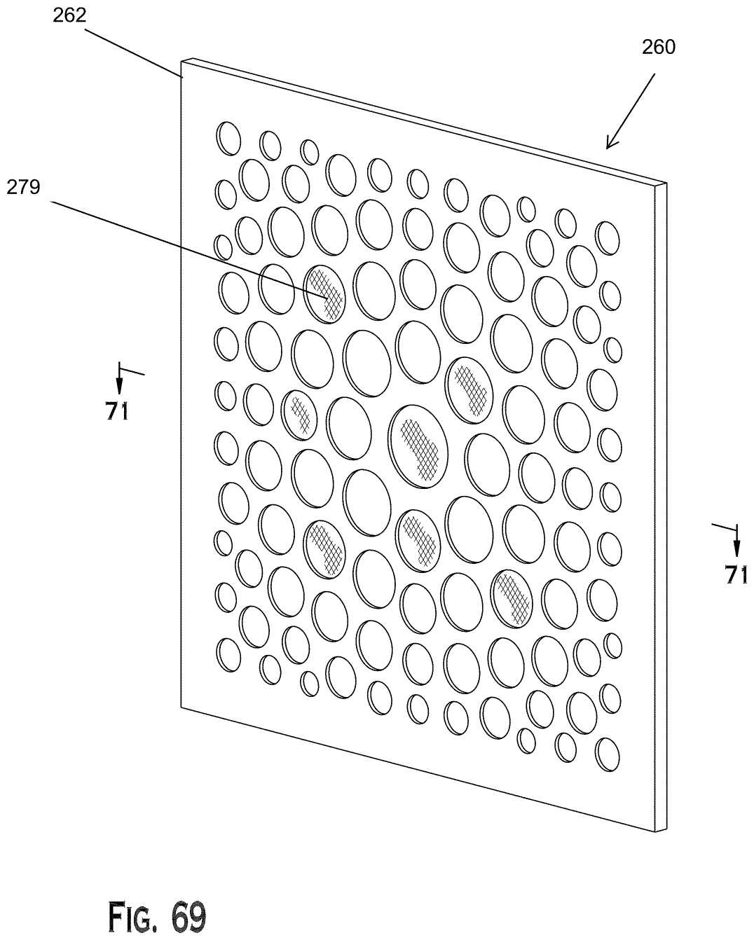

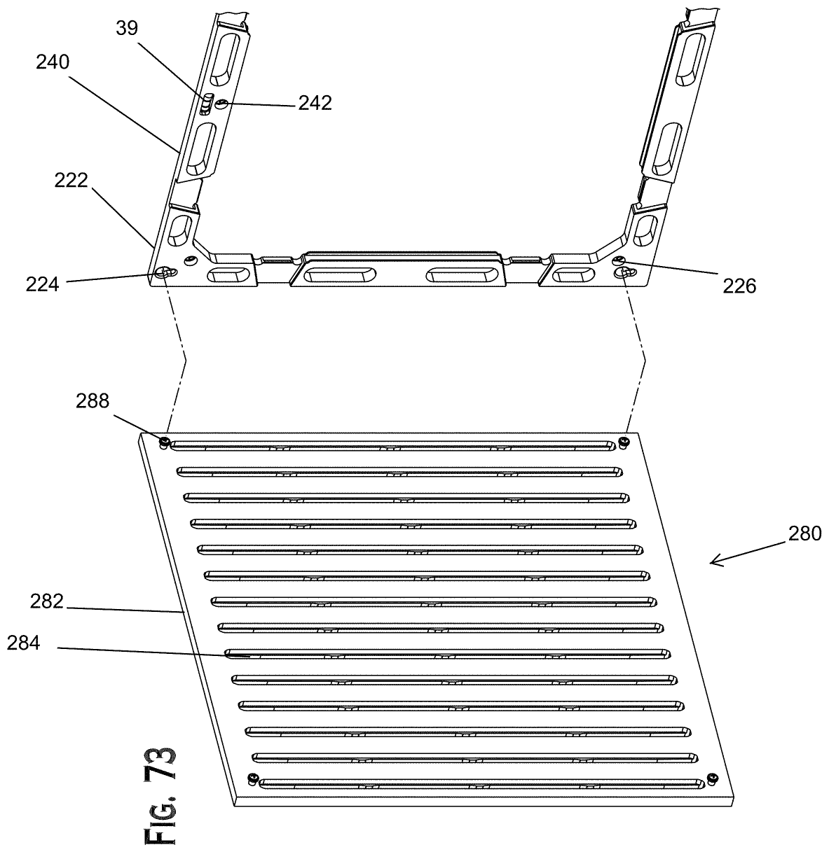

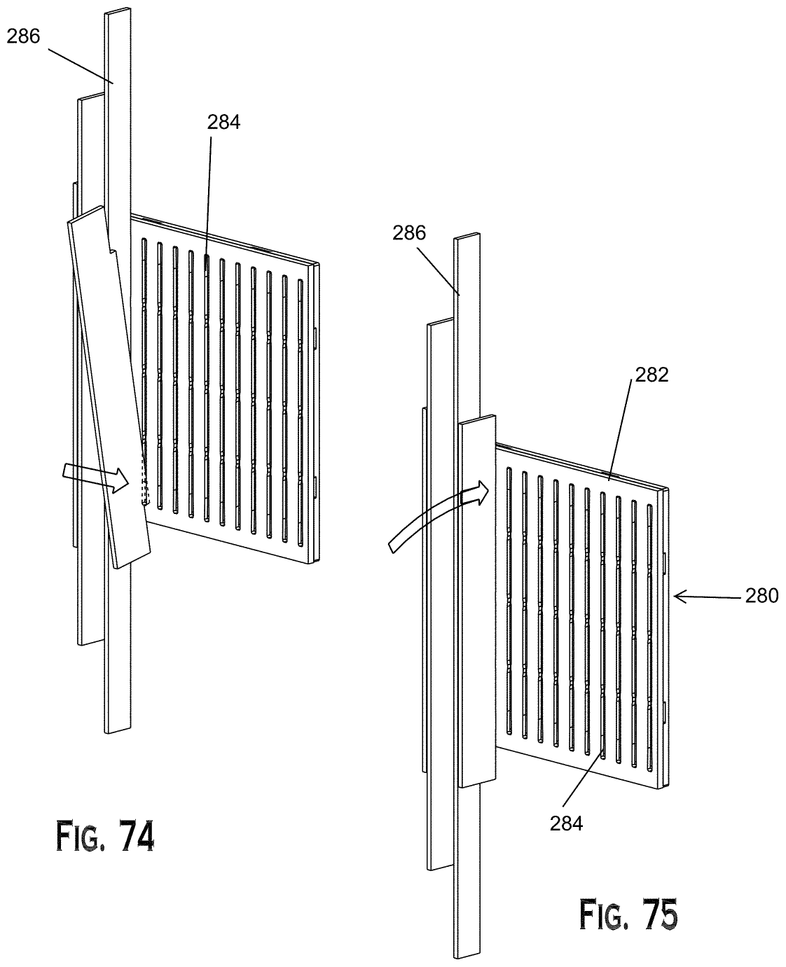

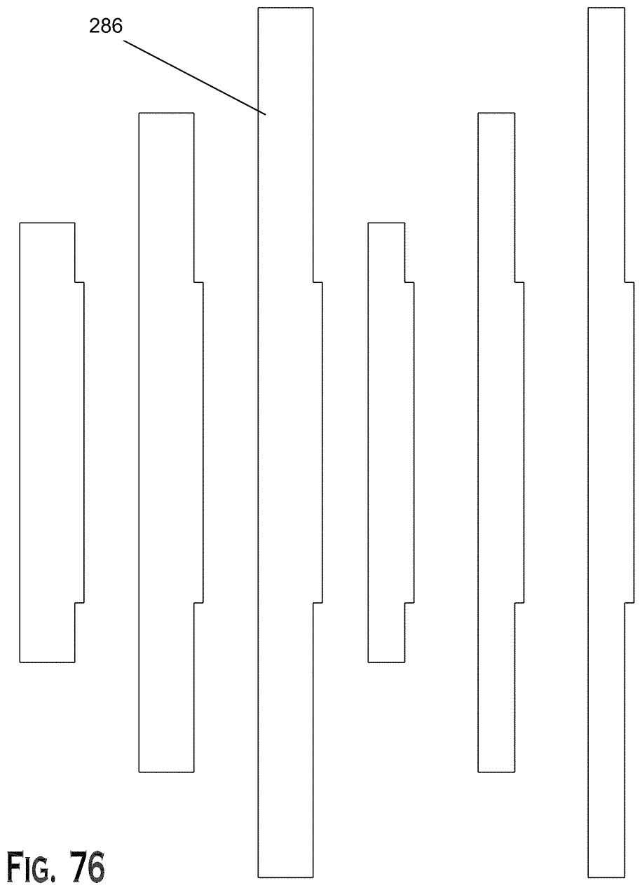

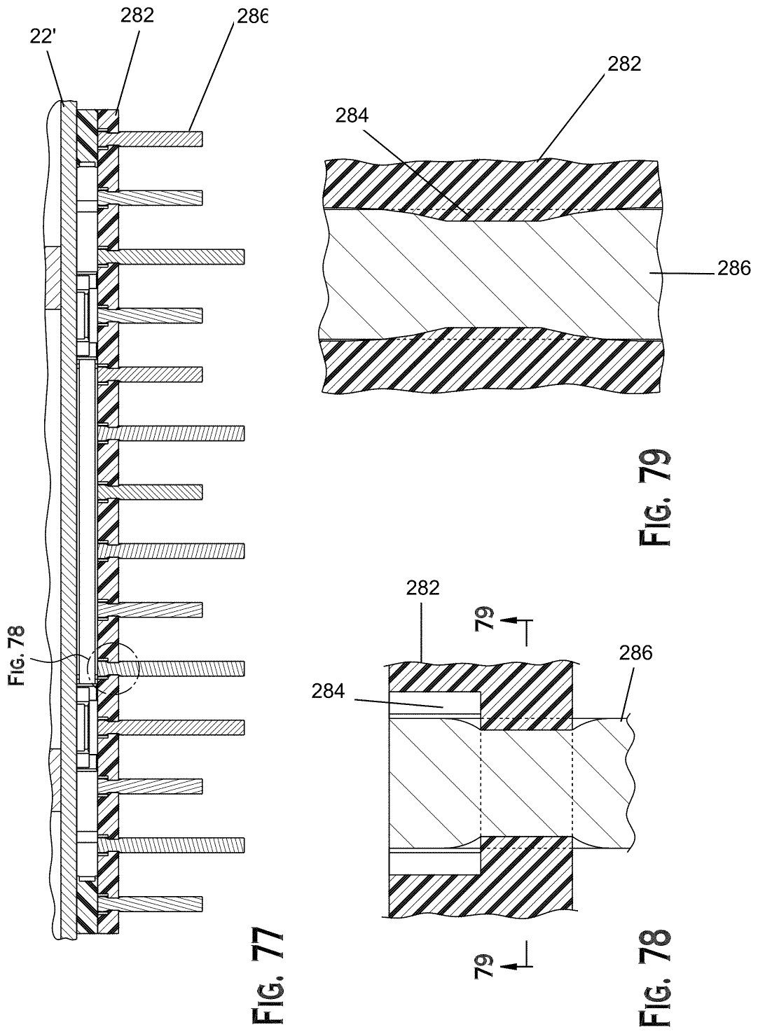

Now with reference to FIGS. 49-82, another modular panel system or assembly 100′ according to the invention is shown. For the sake of brevity, reference numbers refer to like elements and only the differences from the modular panel system or assembly 100 as shown in FIG. 1 will be described in detail herein.

Generally, the assembly 100′ according to another embodiment of the invention generally includes a frame 20′. The frame 20′ further includes a keyhole frame 220, an embedded leveler 240. Moreover, the assembly 100′ further includes the additions of a panel 260 and an on-edge insertion panel 280.

In the exemplary embodiment, the keyhole frame 220 includes a corner member 222. The corner member 222 is angular shaped. One of ordinary skill in the art would understand the applicant's design is not the exclusive embodiment. The keyhole frame 220 further includes a keyhole insert 224 and a mount insert 226. One of ordinary skill in the art would understand the applicant's design is not the exclusive embodiment. The keyhole insert 224 is a front-square-rear-round passageway located towards a far edge of the corner member 222. Specifically, near a right angle of the corner member 222. The keyhole insert 224 further includes an upper insert section 228 and a lower insert section 230 as shown in FIG. 59. The upper insert section 228 is a passageway which allows a fastener to be inserted into the keyhole frame 220. One of ordinary skill in the art would understand the applicant's design is not the exclusive embodiment. The lower insert section 230 is a passageway which the fastener interlocks with and restricts the fastener's movement. One of ordinary skill in the art would understand the applicant's design is not the exclusive embodiment as shown in FIG. 65.

The mount insert 226 is a receiver located near the keyhole insert 224. Specifically, the mount insert 226 is located on an angle with respect to the keyhole insert 224. One of ordinary skill in the art would understand the applicant's design is not the exclusive embodiment. Additionally, the mount insert 226 and the central insert 242, further include a fastener receiving passageway 234 and a head accommodation cavity 236 positioned in front and in communication with the fastener receiving passageway 234. One of ordinary skill in the art would understand the applicant's design is not the exclusive embodiment.

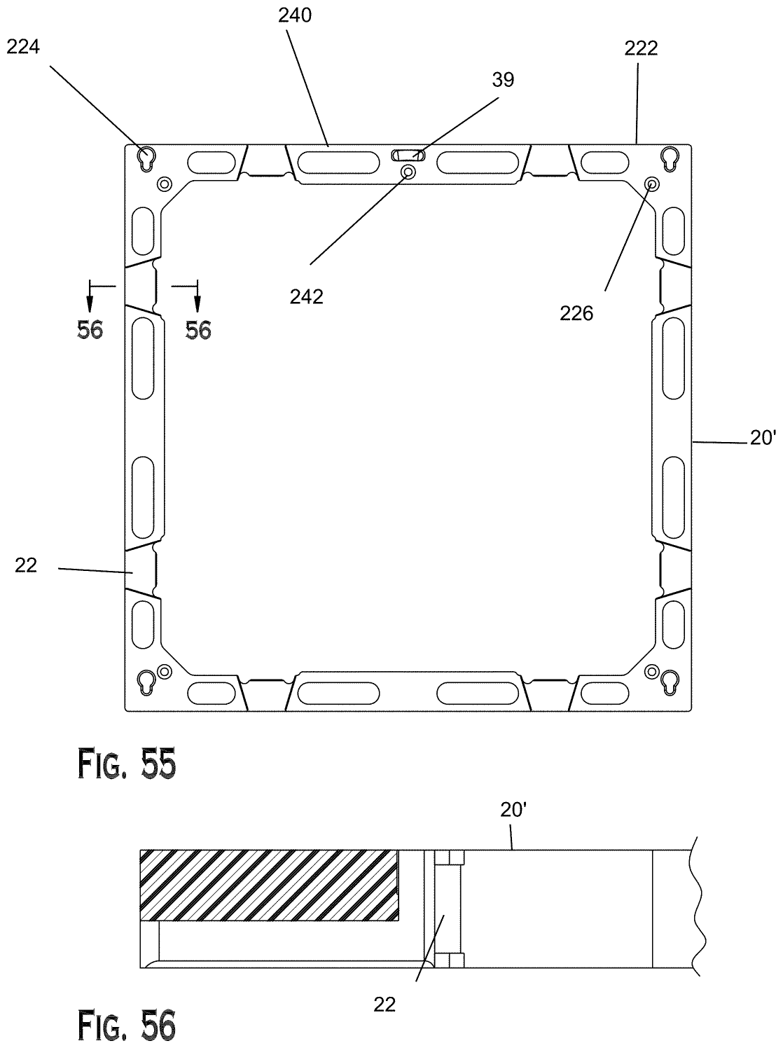

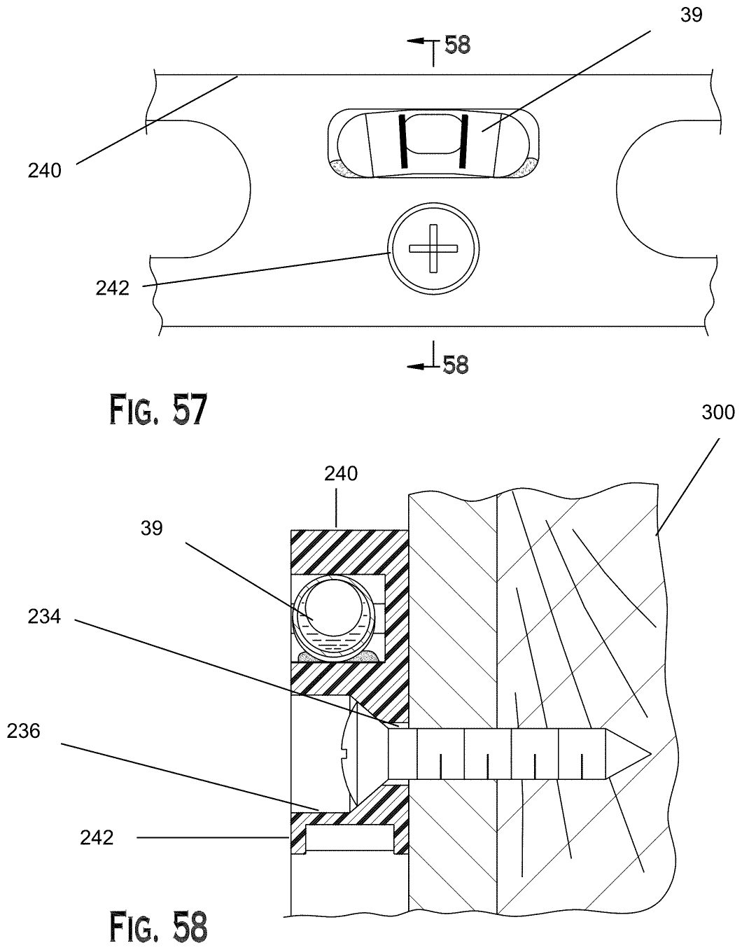

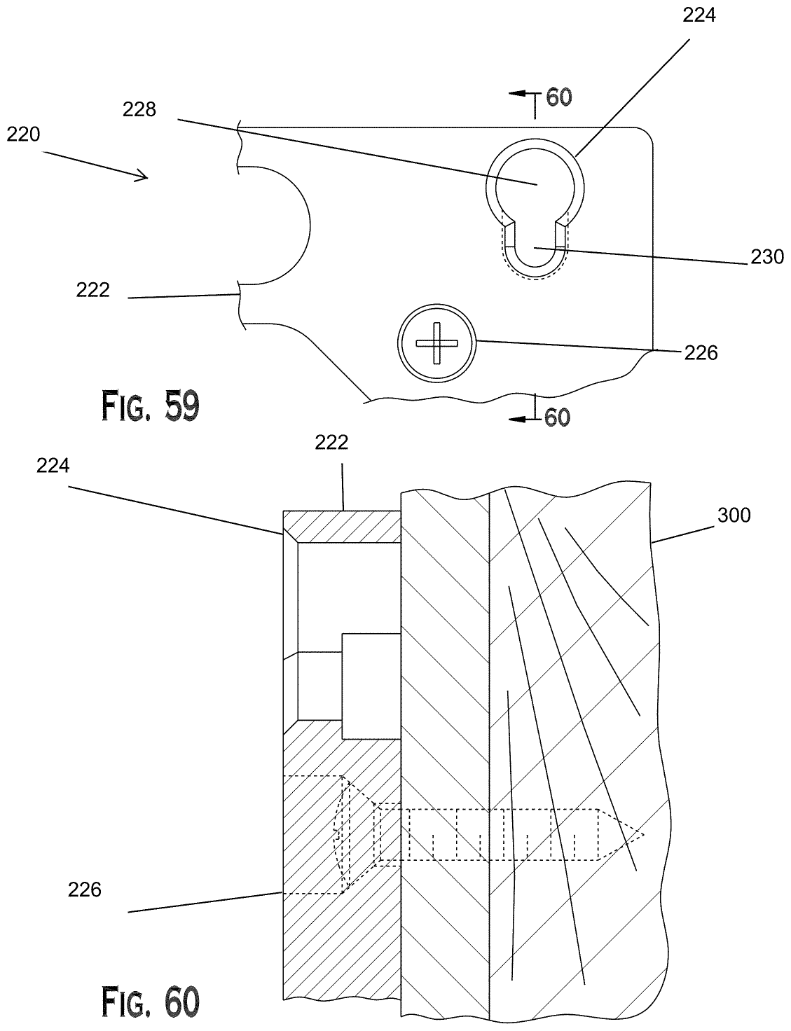

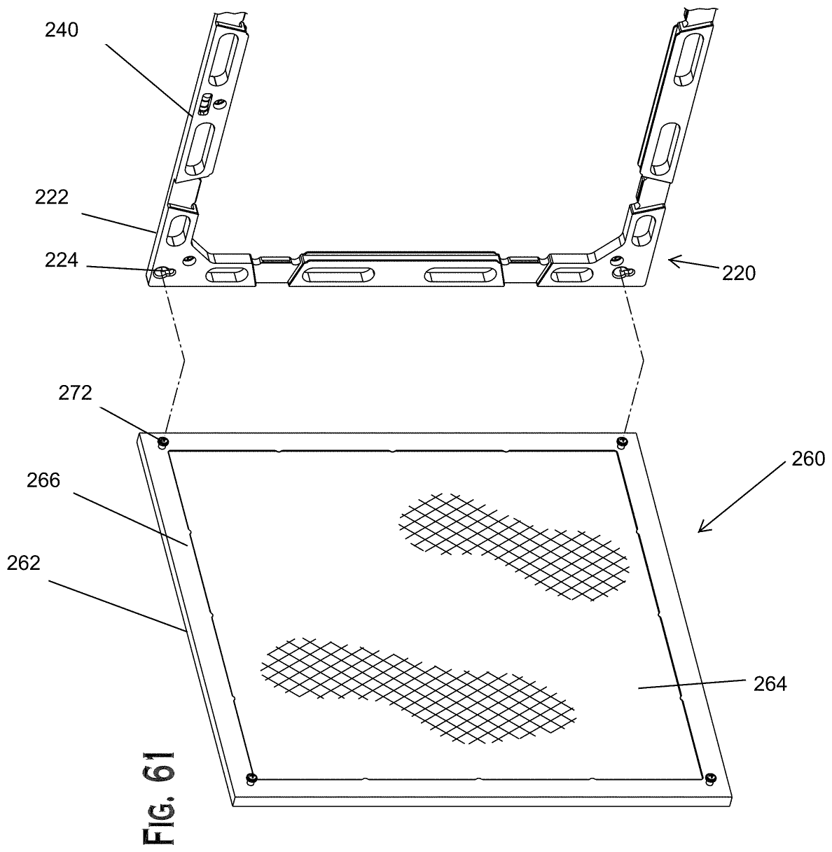

In the exemplary embodiment, the embedded leveler 240 is an elongated member as shown in FIG. 55. The embedded leveler 240 further includes a bubble level 39 similar to what was disclosed previously above. The bubble level 39 is a cylindrical, fluid-filled vial within the embedded leveler 240 of the frame 20′ for aiding in positioning the frame 20′. One of ordinary skill in the art would understand the applicant's design is not the exclusive embodiment. The embedded leveler 240 is located between at least two of the corner members 222. One of ordinary skill in the art would understand the applicant's design is not the exclusive embodiment. The embedded leveler 240 further includes a central insert 242 directly below the bubble level 39. One of ordinary skill in the art would understand the applicant's design is not the exclusive embodiment.

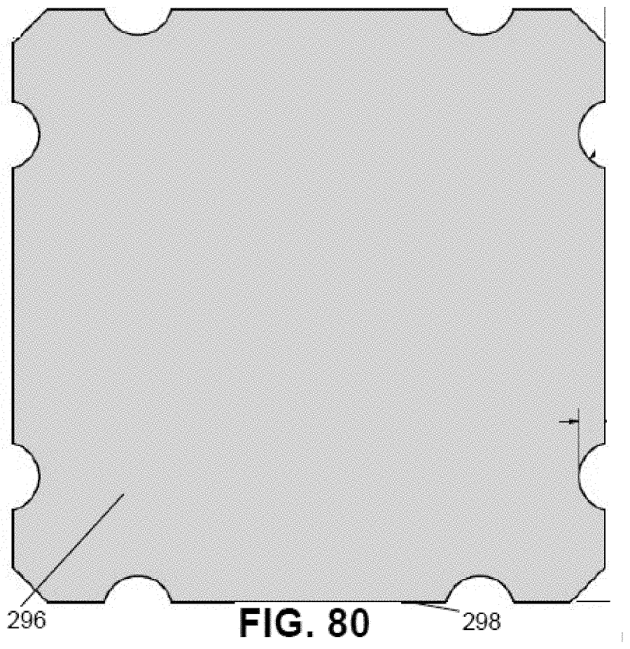

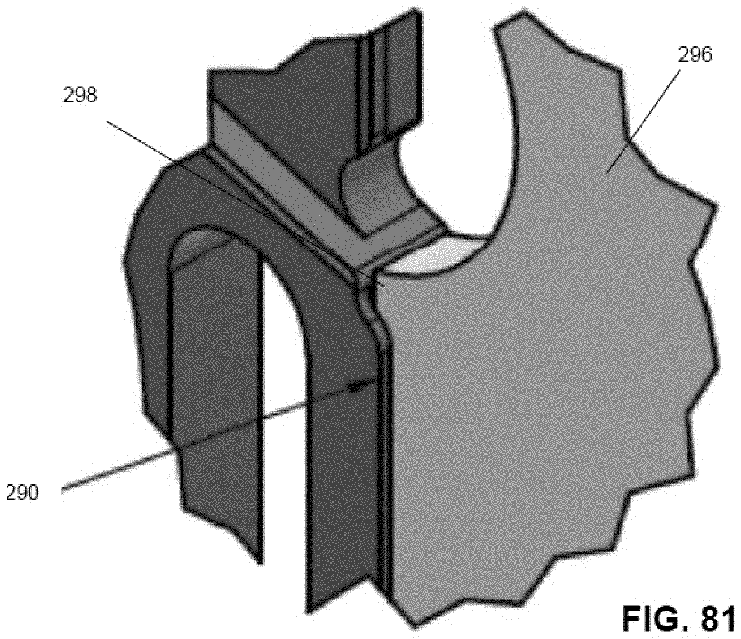

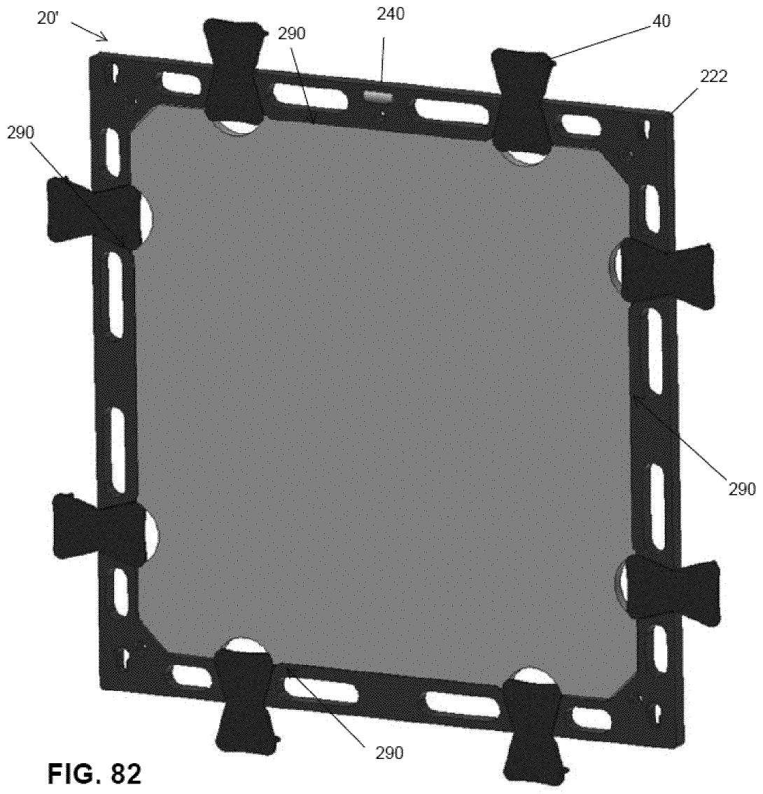

In an embodiment, the frame 20′ further includes a plurality of tabs 290 as shown in FIG. 49 and FIG. 81. The plurality of tabs 290 are protruding walls 292 which create an indent 294 on the interior of the frame 20′. One of ordinary skill in the art would understand the applicant's design is not the exclusive embodiment. Moreover, the plurality of tabs 290 are applied to capture a substrate of a material 279 or a free float panel 296 within the frame 20′ itself as shown in FIGS. 81-82. One of ordinary skill in the art would understand the applicant's design is not the exclusive embodiment. Specifically, a side 298 of the free float panel 296 is inserted and secured within the indent 294 of the tab 290 as shown in FIGS. 80-82. One of ordinary skill in the art would understand the applicant's design is not the exclusive embodiment.

In the exemplary embodiment, the panel 260 includes a panel frame 262, and a backing board 264. The panel frame 262 is a polygon shaped member. The panel frame 262 further includes a raised edging 266 located on the outer perimeter of the panel frame 262. One of ordinary skill in the art would understand the applicant's design is not the exclusive embodiment. The raised edging 266 of the polygon shaped member forms a material insert 268. One of ordinary skill in the art would understand the applicant's design is not the exclusive embodiment. The raised edging 266 further includes a plurality of protrusions 270 located perpendicular to an outer rim of the material insert 268 as shown in FIG. 70. One of ordinary skill in the art would understand the applicant's design is not the exclusive embodiment.

The panel frame 262 further includes a plurality of raised edging fasteners 272 located on the raised edging 266. Specifically, the raised edging fasteners 272 are located near each corner edge of the raised edging 266. One of ordinary skill in the art would understand the applicant's design is not the exclusive embodiment.

In the exemplary embodiment, the raised edging fasteners 272 further includes a spacer 274 as shown in FIG. 63. The spacer 274 further includes a set of sidewalls 275. The sidewalls 275 are plate like members which include a flanged collar 277 positioned at one end of the sidewalls 275 as shown in FIG. 63. One of ordinary skill in the art would understand the applicant's design is not the exclusive embodiment. Moreover, the sidewalls 275 form a panel fastener receiving passageway 276 extending therethrough which permits a panel fastener 278 to be received. One of ordinary skill in the art would understand the applicant's design is not the exclusive embodiment.

In the exemplary embodiment, the on-edge insertion panel 280 includes an insertion frame 282, and a plurality of fins 286. The insertion frame 282 is a polygon shaped member. The insertion frame 282 further includes a plurality of slits 284 located on a vertical plane with respect to the insertion frame 282. One of ordinary skill in the art would understand the applicant's design is not the exclusive embodiment. The insertion frame 282 further includes a plurality of on-edge fasteners 288 located on each corner of the insertion frame 282. One of ordinary skill in the art would understand the applicant's design is not the exclusive embodiment. The plurality of on-edge fasteners 288 include the similar components as the raised edging fasteners 272. One of ordinary skill in the art would understand the applicant's design is not the exclusive embodiment.

In the exemplary embodiment, the plurality of fins 286 are plate like members. The plurality of fins 286 can include measurements of 3″×24″, 3″×36″, 3″×47.5″, 2″×24″, 2″×36″, 2″×47.5″. One of ordinary skill in the art would understand the measurements of the fins 286 are not the only measurements and the design is not the exclusive embodiment. Further, the fins 286 can include a wide variety of colors. One of ordinary skill in the art would understand the applicant's design is not the exclusive embodiment.

In the exemplary embodiment, similar to what was stated above, the frame 20′ allows the user to have the ability to connect multiple frames 20′ using a frame-to-frame connector 40 as recited in great detail above.

In the exemplary embodiment, if the user wanted to utilize the assembly 100′. The user would first pick a mounting surface 300 and run a fastener through the central insert 242 while the user focuses on the bubble level 39 for accurately positioning the frame 20′ as shown in FIGS. 49-50. The fastener is threaded through the central insert 242 and makes contact with the mounting surface 300 for a secure connection. The user then runs the remaining fasteners through the mount inserts 226 of the keyhole frame 220.

If multiple frames are desired, the user will connect the frames 20′ by attaching the plurality of frame-to-frame connectors 40 onto the receiving sections 22 of the frame 20′ as shown in FIGS. 52-56.

In the exemplary embodiment, when utilizing the panel 260, a piece of material 279 is inserted into the material insert 268 of the panel frame 262. The backing board 264 is then inserted over the protrusions 270 and into the material insert 268 in which the piece of material 279 and the backing board 264 become flush. One of ordinary skill in the art would understand the applicants design is not the exclusive embodiment. Alternatively, the backing board 264 may be inserted into the material insert 268 without the addition of first inserting the piece of material 279. One of ordinary skill in the art would understand the applicant's design is not the exclusive embodiment. The user then utilizes the plurality of raised edging fasteners 272 which are inserted through the upper insert section 228 of the keyhole insert 224.

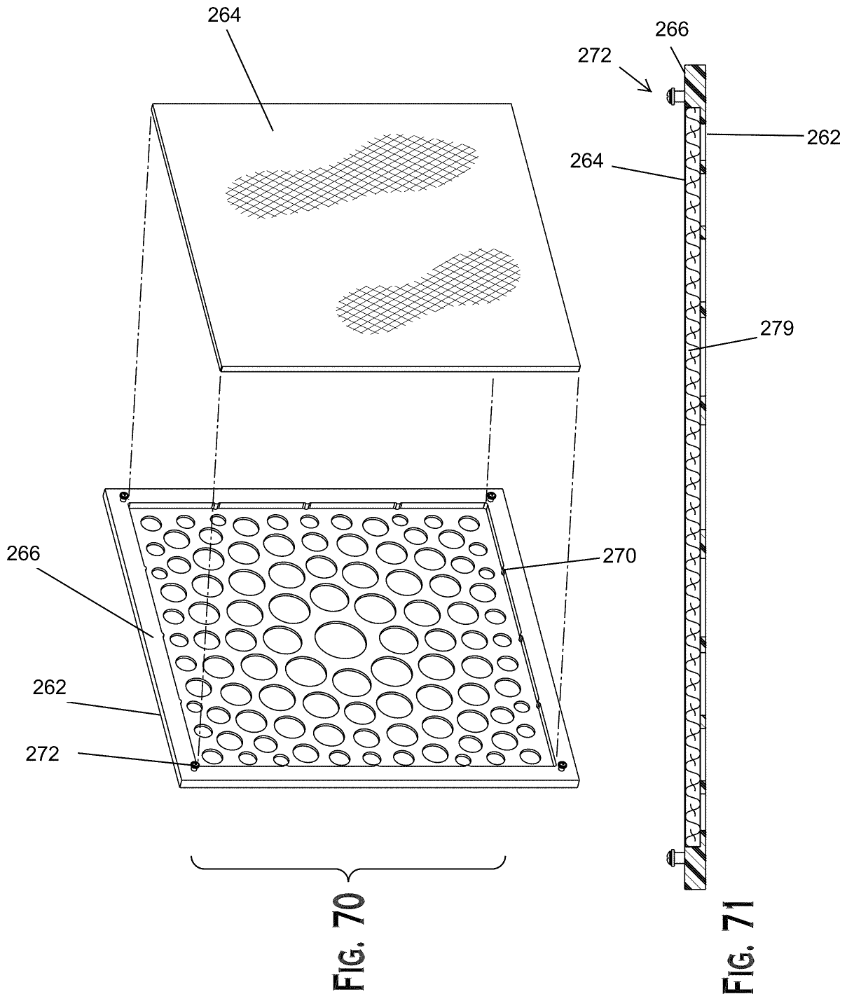

The user will then apply force in a first direction F1. Specifically, it is a force in a downward direction which allows attachment of the plurality of raised edge fasteners 272 to the keyhole insert 224 by way of interlocking with the lower insert section 230. Essentially, the flanged collar 277 and one of the sidewalls 275 have direct contact with the corner member 222 as shown in FIG. 65. When there is an attachment between the keyhole insert 224 and the raised edge fastener 272, the panel 260 becomes flush with the frame 20′. If there are multiple frames 20′, the user will first utilize and connect the lower frames 20′ and then work upwards as shown in FIG. 66.

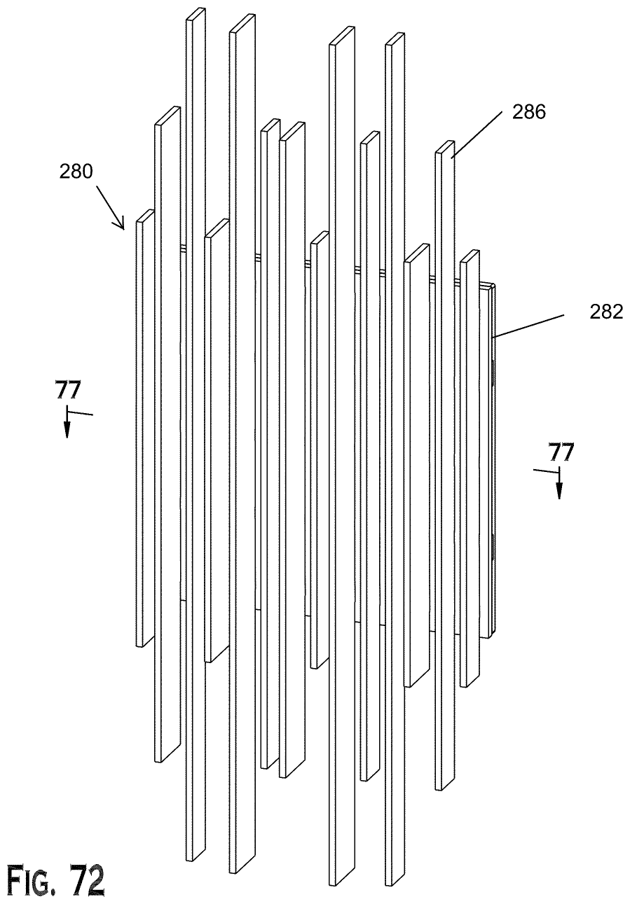

Additionally, one of the panels 260 can be substituted as shown in FIGS. 67-68. In order substitute one of the panels 260 with a second panel 260, the user will need to apply a force in a second direction F2 as shown in FIGS. 67-68. Specifically, it is a force in an upward direction which allows the raised edging fastener 272 to be released from the lower insert section 230 of the keyhole insert 224. Essentially, the sidewall 275 and the flanged collar 277 are removed and are no longer in contact with the corner member 222.

In the exemplary embodiment, when utilizing the on-edge insertion panel 280, the on-edge fasteners 288 are inserted through the keyhole insert 224 of the frame 20′. The user then applies a force in a first direction F1. Specifically, it is a force in the downward direction which allows the on-edge fasteners 288 to be attached and interlock with the lower insert section 230 of the keyhole insert 224. Essentially, the flanged collar 277 and one of the sidewalls 275 have direct contact with the corner member 222. Moreover, when there is an attachment between the keyhole insert 224 and the on-edge fastener 288, the on-edge insertion panel 280 becomes flush with the frame 20′. The plurality of fins 286 are then inserted into the plurality of slits 284 which provides for the user to have numerous combinations of sized and shaped fins 286 displays.

Additionally, one on-edge insertion panel 280 may be substituted with a second on-edge insertion panel 280 by applying a force in second direction F2. Specifically, it is a force applied in an upward direction which allows the on-edge fasteners 288 to be released from the lower insert section 230 on the keyhole insert 224. Moreover, the sidewall 275 and the flanged collar 277 are removed and are no longer in contact with the corner member 222. The on-edge fastener 288 is then removed from the keyhole insert 224.

While the foregoing invention has been described with reference to the above described embodiment, various modifications and changes can be made without departing from the spirit of the invention. Accordingly, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure.

This Detailed Description, therefore, is not to be taken in a limiting sense, and the scope of various embodiments is defined only by the appended claims, along with the full range of equivalents to which such claims are entitled. Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown.

This disclosure is intended to cover any and all adaptions of variations of various embodiments. Combinations of the above embodiments, and other embodiments not specifically described herein, will be apparent to those of skill in the art upon reviewing the above description.

What is claimed is:

1. A modular display system, comprising:
a frame having peripheral sidewalls with a plurality of keyhole inserts and mount inserts provided thereabout, each of the plurality of keyhole inserts includes an upper insert section and a lower insert section positioned below and in communication with the upper insert section, each of the plurality of mount inserts includes a fastener receiving passageway and a head accommodation cavity positioned in front and in communication with the fastener receiving passageway; and
a panel having a frame with a plurality of raised edging fasteners positioned to correspond with the plurality of keyhole inserts, each of the plurality of raised edging fasteners having a spacer with spacer walls and a flanged collar positioned on top of the spacer walls, the spacer wall dimensioned to fit in the lower insert section and the flanged collar spaced to fit in the upper insert section.

2. The modular display system of claim 1, wherein a force in a first direction is applied for locking the plurality of raised edging fasteners to the keyhole inserts.

3. The modular display system of claim 2, wherein a force in a second direction is applied for unlocking the plurality of raised edging fasteners to the keyhole inserts.

4. The modular display system of claim 1, wherein the frame further includes an embedded leveler.

5. The modular display system of claim 4, wherein the embedded leveler further includes a central insert.

6. The modular display system of claim 5, wherein the embedded leveler further includes a bubble level.

7. The modular display system of claim 6, wherein the central insert is positioned below the bubble level.

8. The modular display system of claim 7, wherein the frame further includes a corner member in which the keyhole insert is positioned.

9. The modular display system of claim 8, wherein the mount insert is positioned through the corner member.

10. The modular display system of claim 9, wherein the mount insert is positioned angular to the keyhole insert.

11. The modular display system of claim 1, wherein the panel further includes a backing board.

12. The modular display system of claim 11, wherein the panel further includes a raised edging.

13. The modular display system of claim 12, wherein the panel further includes a plurality of protrusions.

14. The modular display system of claim 11, wherein the panel further includes a material insert.

15. The modular display system of claim 14, wherein the raised edging fasteners are located on the raised edging.

16. The modular display system of claim 15, wherein the modular display assembly further includes an on-edge insertion panel.

17. The modular display system of claim 16, wherein the on-edge insertion panel includes an insertion frame.

18. The modular display system of claim 17, wherein the insertion frame includes a plurality of slits.

19. The modular display system of claim 18, wherein the on-edge insertion panel further includes a plurality of fins.

20. The modular display system of claim 19, wherein the panel of a plurality of panels can be substituted with a second panel of the plurality of panels.
